(19) United States
(12) Patent Application Publication
(10) Pub. No.: US 2011/0053803 A1
(43) Pub. Date: Mar. 3, 2011

(54) METHODS FOR CREATING ANTIBODY LIBRARIES

(76) Inventors: Xin Ge, Austin, TX (US); Yariv Mazor, North Bethesda, MD (US); George Georgiou, Austin, TX (US)

(21) Appl. No.: 12/868,399

(22) Filed: Aug. 25, 2010

Related U.S. Application Data
(60) Provisional application No. 61/236,981, filed on Aug. 26, 2009.

(51) Int. Cl. C40B 50/06; C40B 40/08; C40B 40/10

(52) U.S. Cl. 506/17; 506/26; 506/18

(57) ABSTRACT

Methods and composition for the preparation of gene libraries of antibodies or parts of antibodies which contain the variable domains. For example, in certain aspects methods for providing polynucleotide library involving annealing and extending are described. Furthermore, the invention provides polynucleotide or antibody fragment libraries prepared by the methods.

### PRIORITY CLAIM

The present application claims benefit of priority to U.S. Provisional Application Ser. No. 61/236,981, filed Aug. 26, 2009, the entire contents of which are hereby incorporated by reference.

### BACKGROUND OF THE INVENTION

1. Field of the Invention

The present invention relates generally to the field of combinatory library construction. More particularly, it concerns novel methods for generating libraries of nucleotide or peptide sequences related to antibody variable domains.

2. Description of Related Art

Currently recombinant therapeutic antibodies have sales of well over $20 billion/year and with a forecast of annual growth rate of 20.9%, they are projected to increase to $33 billion/year by 2012 (Therapeutic Monoclonal Antibodies Report 2008-2023 (2) world wide web at businesswire.com/news/home/20090625005575/en). Monoclonal antibodies (mAbs) comprise the majority of recombinant proteins currently in the clinic, with more than 150 products in studies sponsored by companies located worldwide (Pavlou and Belsey, 2005). In terms of therapeutic focus, the mAb market is heavily focused on oncology and arthritis, immune and inflammatory disorders, and products within these therapeutic areas are set to continue to be the key growth drivers over the forecast period. As a group, genetically engineered mAbs generally have higher probability of FDA approval success than small-molecule drugs. At least 50 biotechnology companies and all the major pharmaceutical companies have active antibody discovery programs in place.

The original method for isolation and production of mAbs was first reported at 1975 by Milstein and Kohler (Kohler and Milstein, 1975), and it involved the fusion of mouse lymphocyte and myeloma cells, yielding mouse hybridomas. Therapeutic murine mAbs entered clinical study in the early 1980s; however, problems with lack of efficacy and rapid clearance due to patients' production of human anti-mouse antibodies (HAMA) became apparent. These issues, as well as the time and cost consuming related to the technology became driving forces for the evolution of mAb production technology.

Polymerase Chain Reaction (PCR) facilitated the cloning of monoclonal antibody genes directly from lymphocytes of immunized animals and the expression of combinatorial library of fragments antibodies in bacteria (Orlandi et al., 1989). Later libraries were created entirely by in vitro cloning techniques using naïve genes with rearranged complementarity determining region 3 (CDR3) (Griffiths and Duncan, 1998; Hoogenboom et al., 1998). As a result, the isolation of antibody fragments with the desired specificity was no longer dependent on the immunogenicity of the corresponding antigen. Moreover, the range of antigen specificities in synthetic combinatorial libraries was greater than that found in a panel of hybridomas generated from an immunized mouse. These advantages have facilitated the development of antibody fragments to a number of unique antigens including small molecular compounds (haptens) (Hoogenboom and Winter, 1992), molecular complexes (Chames et al., 2000), unstable compounds (Kjaer et al., 1998) and cell surface proteins (Desai et al., 1998).

However, the requirement of PCR and/or cloning in the above library construction methods limit the functional library size and introduces undesired errors. Therefore, there remains a need to develop a more efficient and accurate method for generating a library of antibodies or parts there of, which contain a diversity of variable domains.

### SUMMARY OF THE INVENTION

The present invention overcomes a major deficiency in the art by providing a library of antibodies or variable domains with diversified regions and coding sequences thereof. In a first embodiment, there is provided a method of preparing a vector, comprising the steps of: a) annealing a first population of polynucleotides with at least a second population of polynucleotides, the first population comprising nucleotide sequences encoding an immunoglobulin complementarity determining region (CDR), wherein the CDR is diversified at one or more amino acid positions, the at least a second population comprising nucleotide sequences complementary to the nucleotide sequences comprised in the first population; b) preparing one or more double-stranded polynucleotides comprising nucleotide sequences encoding an immunoglobulin variable domain that incorporates the diversified CDR from extending strands of the annealed polynucleotides; and c) inserting the double-stranded polynucleotides into a vector to provide a library of vectors, with two or more members of said library comprising different antibody coding sequences, wherein steps a), b) and c) are performed without the use of PCR amplification. In some embodiments an in-frame selection step is employed to significantly reduce the number of sequences that contain stop codons or deletions and thus do not encode functional antibodies. The method may further comprise introducing the library of vectors into host cells and optionally further comprise culturing and separating the host cells into two or more individual clonal colonies.

The method may further comprise expressing the double-stranded polynucleotides to produce a library of antibodies that comprise diversified variable domains or CDR(s). For example, the vector may comprise sequences encoding an antibody framework, which may include regions other than variable domains, such as constant domains. By expressing the variable domain sequences prepared by the methods described herein along with the antibody framework, a library of full-length antibodies with diversified CDR(s) may be obtained.

In a second embodiment, there is also provided a method of preparing a library of polynucleotides, comprising the steps of: a) providing a first population of polynucleotides, the first population comprising nucleotide sequences encoding an immunoglobulin complementarity determining region (CDR), wherein the CDR is diversified at one or more amino acid positions; b) providing at least a second population of polynucleotides, the at least a second population comprising nucleotide sequences complementary to the nucleotide sequences comprised in the first population and capable of annealing to the first population of polynucleotides to form annealed polynucleotides that comprise nucleotide sequences encoding an immunoglobulin variable domain, wherein the immunoglobulin variable domain comprises the diversified CDR and an additional CDR; c) annealing the polynucleotides of the first population and the polynucleotides of the at least a second population to produce a library of polynucleotides; and d) extending strands of the annealed polynucleotides to prepare a library of double-stranded polynucleotides.

In certain aspects, the double-stranded polynucleotides may be amplified or directly inserted into a vector to provide a library of vectors, with two or more members of said library comprising different antibody coding sequences. The method may further comprise introducing the library of vectors into host cells and optionally further comprise culturing and separating the host cells into two or more individual clonal colonies.

For preparing the polynucleotides, nucleotide chemical synthesis or any other methods known in the art may be involved. To obviated the need of PCR amplification, polynucleotides of at least or at most about 50, 75, 90, 140, 180, 250, 300, 400, 500, or any lengths derivable therein, may be used for the present methods, which may be suitable for annealing-mediated library construction. In certain further embodiments, the invention involves using two, three, four or more different populations of polynucleotides with complementary sequences among them for annealing. Complementary sequences may include portions of FR1, FR2, FR3, FR4, CDR2, or any regions not diversified.

In still further aspects of the invention, diversified variable domains are prepared by incorporating diversified CDR, such as CDR1, CDR2, CDR3, or a combination thereof, particularly like diversified CDR3, diversified CDR1 and CDR2, or all three diversified CDRs, derived from heavy chain or light chain variable domains.

Preferably, the step of extending of the annealed polynucleotides may use any polymerases that does not have strand displacement activity, such as T4 DNA polymerase. The extending step or any of the above the methods may also involving filling in the gaps on the double-stranded polynucleotides, for example by using a ligase, such as a T4 ligase. The immunoglobulin variable domain encoded by the double-stranded polynucleotides prepared above may be a complete immunoglobulin variable domain or a portion thereof.

For expression of the coding sequences, the vector with the double-stranded polynucleotides inserted may be an expression vector, such as a microbial expression vector, e.g., E. coli expression vector. The expression vector may comprise coding sequences for an antibody framework to generate an antibody library expressing diversified immunoglobulin variable domains. In the case of an E. coli expression vector, E-clonal technology could be used for screen of immunoglobulin variable domains.

In some further aspects, a polynucleotide library prepared by any of the methods above or a diversified antibody library comprising amino acid sequences encoded by the polynucleotide library may be provided.

Embodiments discussed in the context of methods and/or compositions of the invention may be employed with respect to any other method or composition described herein. Thus, an embodiment pertaining to one method or composition may be applied to other methods and compositions of the invention as well.

As used herein the terms “encode” or “encoding” with reference to a nucleic acid are used to make the invention readily understandable by the skilled artisan; however, these terms may be used interchangeably with “comprise” or “comprising” respectively.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the method being employed to determine the value, or the variation that exists among the study subjects.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. Sequences of VH and Vκ with designed coverage and theoretical diversity of each CDRs (SEQ ID NO:20 and 21).

FIGS. 2A-2C. Construction of VH/Vκ gene libraries. FIG. 2A. Structure of antibody variable domain genes. The bolded regions represent CDRs. FIG. 2B. Procedure to assemble VH/Vκ gene libraries. Primers with length ranging from 90 mer to 140 mer were designed to having overlapping segments at FRs, while CDR1, CDR2, CDR3 were encoded by primer 2, primer 3, primer 4 respectively (Table 3). Polynucleotides were chemically synthesized, then PAGE purified. Primer 2 and 3 were 5′-phosphorylated. After annealing, the gaps were filled by treatment with T4 DNA polymerase and T4 DNA ligase simultaneously, generating double-stranded VH/Vκ fragments ready for restriction digestion and cloning. FIG. 2C. Electrophoresis investigation of VH gene after anneal and fill-in reaction (390 bp, theoretically).

FIGS. 3A-3C. In-frame selection of VH/Vκ genes from libraries. FIG. 3A. Constructions of selection vector pVH-bla/pVL-bla. The 24-287 aa of β-lactamase was fused to the C-terminal of VH/Vκ with a linker ASFG/RTAAA (SEQ ID NO:1). Cholamphenicol resistant gene presents on the backbone of the plasmids. FIG. 3B. Verifying gene completeness of 6 known VH clones using IgG expression vector pMAZ. A07, B07, and B11 carry full-length VH fragment; B10 and A19 have reading frame shifts; B06 has stop codon in CDR-H3. Membrane was western-blotted with anti-IgG antibody. FIG. 3C. Evaluation of selection vector pVH-bla. These 6 VH genes were cloned into pVH-bla, and cultured on agar plates with different antibiotic supplementations: Cam⁺ (left); Amp⁺ (middle); Amp⁺/Cam⁺ (right).

FIG. 4. Sequencing results of selected Vκ genes. ˜93% (43/46) are full-length (SEQ ID NOS:22-64).

FIG. 5. Sequencing results of selected VH genes. 100% (54/54) are full-length. FIGS. 6A-B. High throughput DNA sequencing of library clones. DNA sequence length distribution from data obtained by 454 sequencing technology. (FIG. 6A) pre-selection sample. (FIG. 6B) post-selection sample (SEQ ID NOS:65-117).

FIG. 7. Program flow chart of data mining.

FIG. 8. Amino acid composition of CDR-H2 evaluated from the analysis of the high throughput sequencing data. At each position, bars show the expected theoretical design (left), pre-selection (middle), and post-selection (right) amino acid occupancy. Sample sizes are 36,609 sequences for pre-selection, and 26,439 sequences for post-selection.

FIG. 9. Amino acid composition of CDR-H1, L1, and L2 in the post-selection samples. The sequence sample sizes are 27,155, 23,925, 18,889 and 43,340 for CDR-H1, L1a (11 aa), L1b (12 aa), and L2 respectively.

FIGS. 10A-B. Statistical analysis results of amino acid composition of CDR3s for samples before and post in-frame selection. (FIG. 10A) CDR-H3 designed to contain a 6 NNS sequence. 8,069 and 6,072 sequences for pre- and post-selection samples were obtained. Stop codon contents were depleted from 3.47±0.55% to 0.11±0.04%. (FIG. 10B) CDR-L3. Sequence sizes are 80,537 and 38,356 sequences for pre and post-in-frame selection. Stop codon content decrease from 2.26±0.47% to 0.70±0.23%. No significant composition changes are found for other amino acids.

FIGS. 11A-C. Distance score profiles of CDR-L3, H2, H3 (9 NNS) in post-selection samples, and their comparison with simulation results. Sample size of CDR-H3 (9 NNS) is 5024. 2000 readings were randomly chosen from the sequence pools of CDR-L3 and H2, and used to calculate distance scores. Note, * indicates duplicated readings are found, and these are likely generated through sequencing process.

FIGS. 12A-C. Distance score profiles of CDR-H3 with 6-8 NNS in post-selection samples, and their comparison with simulation results. Sample sizes are 6072, 7122, 6098 sequences respectively. Note, * indicates duplicated readings are found, and these are likely generated through sequencing process.

### DESCRIPTION OF ILLUSTRATIVE EMBODIMENTS

### I. The Present Invention

The instant invention overcomes several major problems with current library construction technologies in providing methods for antibody library construction based on annealing and extension of synthetic polynucleotides in certain aspects. The present invention has the object of developing a generally usable method for generating specific monoclonal antibodies, which contain synthetic variable domains. Specifically, populations of polynucleotides (preferably 90-140 nucleotides) comprising overlapping regions and coding sequences for diversified CDRs are annealed and extended to prepare coding sequences for diversified antibody variable domains.

For most antibody library construction methods in the art, quality and functional size of the library is limited by inefficient PCR cloning of antibody genes using degenerated primers. PCR using this type of primers is difficult to optimize conditions for efficient amplification, and therefore causes loss of antibody diversities. Moreover, PCR-based method usually gives high error rate and bias among diversity. In the present invention, the novel design of long, overlapping polynucleotides combined with the improvement in chemically synthesizing long polynucleotides in large quantity with high purity allows yielding full-length antibody variable domains in the absence of PCR amplification and avoids the various errors and inefficiencies associated with PCR cycling. In addition, the present methods may not need a template, with both strands of the annealed pairs elongating at the same time for improved efficiency. These novel methods enable assembly of variable domain gene segments containing diversified CDRs in a much more controlled and efficient fashion. Further embodiments and advantages of the invention are described below. The method described in this invention is extremely simple, and gene libraries with multiple randomized regions are generated very rapidly in a single reaction. For example, the extending polymerase used in this invention may have excellent fidelity (estimated at one mis-incorporation per 10⁷ residues), and enable to generate variable gene libraries in a high fidelity fashion (i.e. very low unwanted mutations in constant regions). Overall, the nature of elongation by high fidelity polymerase without PCR amplification gives this method unique advantages comparing to PCR-based manners, in terms of reserving designed diversity and minimizing bias among variable regions, and high accuracy in the constant regions.

### II. Definitions

Unless defined otherwise, all technical and scientific terms used herein have the meaning commonly understood by one of ordinary skill in the art relevant to the invention. The definitions below supplement those in the art and are directed to the embodiments described in the current application.

The term “antibody” is used herein in the broadest sense and specifically encompasses at least monoclonal antibodies, polyclonal antibodies, multi-specific antibodies (e.g. bispecific antibodies), chimeric antibodies, humanized antibodies, human antibodies, and antibody fragments. An antibody is a protein comprising one or more polypeptides substantially or partially encoded by immunoglobulin genes or fragments of immunoglobulin genes. The recognized immunoglobulin genes include the kappa, lambda, alpha, gamma, delta, epsilon and mu constant region genes, as well as myriad immunoglobulin variable region genes.

“Antibody fragments” comprise a portion of an intact antibody, for example, one or more portions of the antigen-binding region thereof. Examples of antibody fragments include Fab, Fab′, F(ab′)2, and Fv fragments, diabodies, linear antibodies, single-chain antibodies, and multi-specific antibodies formed from intact antibodies and antibody fragments.

An “intact antibody” is one comprising full-length heavy- and light-chains and an Fc region. An intact antibody is also referred to as a “full-length, heterodimeric” antibody or immunoglobulin.

The term “variable” refers to the portions of the immunoglobulin domains that exhibit variability in their sequence and that are involved in determining the specificity and binding affinity of a particular antibody.

As used herein, “antibody variable domain,” refers to a portion of the light and heavy chains of antibody molecules that include amino acid sequences of Complementary Determining Regions (CDRs; i.e., CDR1, CDR2, and CDR3), and Framework Regions (FRs; i.e., FR1, FR2, FR3, and FR4). FR include those amino acid positions in an antibody variable domain other than CDR positions as defined herein. VH refers to the variable domain of the heavy chain. VL refers to the variable domain of the light chain. A “complete immunoglobulin variable domain” as used herein, refers to amino acid sequences including three CDRs (CDR1, CDR2 and CDR3) and the regions connecting these CDR regions.

Variability is not evenly distributed throughout the variable domains of antibodies; it is concentrated in sub-domains of each of the heavy and light chain variable regions. These sub-domains are called “hypervariable” regions or “complementarity determining regions” (CDRs). The more conserved (i.e., non-hypervariable) portions of the variable domains are called the “framework” regions (FR). The variable domains of naturally occurring heavy and light chains each comprise four FR regions, largely adopting a β-sheet configuration, connected by three hypervariable regions, which form loops connecting, and in some cases forming part of, the β-sheet structure. The hypervariable regions in each chain are held together in close proximity by the FR and, with the hypervariable regions from the other chain, contribute to the formation of the antigen-binding site (see Kabat et al., 1991, incorporated by reference in its entirety). The constant domains are not directly involved in antigen binding, but exhibit various effector functions, such as, for example, antibody-dependent, cell-mediated cytotoxicity and complement activation.

As used herein, the term “diversity” refers to a variety or a noticeable heterogeneity. The term “sequence diversity” refers to a variety of sequences which are collectively representative of several possibilities of sequences, for example, those found in natural human antibodies. The term “length diversity” refers to a variety in the length of a particular nucleotide or amino acid sequence. For example, in naturally occurring human antibodies, the heavy chain CDR3 sequence varies in length, for example, from about 3 amino acids to over about 35 amino acids, and the light chain CDR3 sequence varies in length, for example, from about 5 to about 16 amino acids.

As used herein, the term “complementary nucleotide sequence” refers to a sequence of nucleotides in a single-stranded molecule of DNA or RNA that is sufficiently complementary to that on another single strand to specifically hybridize to it with consequent hydrogen bonding.

The term “library of polynucleotides” refers to two or more polynucleotides having a diversity as described herein, specifically designed according to the methods of the invention. The term “library of polypeptides” refers to two or more polypeptides having a diversity as described herein, specifically designed according to the methods of the invention.

As described throughout the specification, the term “library” is used herein in its broadest sense, and also may include the sub-libraries that may or may not be combined to produce libraries of the invention.

As used herein, the term “synthetic polynucleotide” refers to a molecule formed through a chemical process, as opposed to molecules of natural origin, or molecules derived via template-based amplification of molecules of natural origin.

As used herein, the term “expression” includes any step involved in the production of a polypeptide including, but not limited to, transcription, post-transcriptional modification, translation, post-translational modification, and secretion.

### III. Methods of Antibody Diversification and Library Construction

Certain aspects of the present invention provide a novel method for preparing an antibody library by extending annealed polynucleotides with diversified regions. Generally, the method may combine one or more of the following elements: design and synthesis of polynucleotides; annealing of polynucleotides; strand extension of annealed polynucleotides; expression of the extended products to generate antibody libraries; selection and screen of antibody libraries.

For antibody library construction, polynucleotide primers are preferably designed based on two aspects: introducing diversity and sharing overlapping regions (i.e., complementary sequences). Diversity of antibody variable domains may be introduced by randomization, for example, with NNS trinucleotides for all 20 amino acids or with a degenerate codon that encode for a selection of several amino acids (Fellouse et al., 2007; Fellouse et al., 2004); or by mimicking natural diversity using degenerate codons such as in Tables 1 and 2; or a combination thereof. Consideration needs be taken to avoid protein misfolding and aggregation, as well as unwanted stop codons and cysteine residues, which would generate truncated antibody fragments or disturb disulfide bond formation, respectively. The diversity could also be introduced into one to six of all six CDR regions in both the heavy and light chains, usually resulting in diversified CDR-H3 (the major binding determinant in most antibodies) in combination with additional diversified CDR loops.

A full-length variable domain, composed of 110-130 amino acids, is subdivided into hypervariable (i.e., complementarity determining) and framework (FR) regions. Hypervariable regions (i.e., CDRs) have a high ratio of different amino acids in a given position, relative to the most common amino acid in that position. Within light and heavy chains, three CDRs exist—CDR 1, 2 and 3. Four FR regions (FR 1, 2, 3, and 4) on both light and heavy chains which have more conserved amino acids sequences separate the corresponding three CDRs. To construct a complete V_{H} or V_{L} in certain aspects of the present invention, diversified variable domain-coding sequences may be prepared by annealing two, three, or four different polynucleotides with overlapping regions. Overlapping regions of different polynucleotides would be located in non-diversified regions, preferably any FR regions or some less variable CDR regions, such as CDR2.

Preferably, all six CDRs can be diversified to improve the library size and overlapping regions are located in one or more FRs. In this scenario, a combination of four polynucleotides (ranging from 90 to 140 nucleotides) may be provided to encode at least part of: scheme 1) FR1, FR1+CDR1+FR2, FR2+CDR2+FR3, FR3+CDR3+FR4, respectively, with overlapping regions at FR1, FR2, and FR3; or scheme 2) FR1+CDR1+FR2, FR2+CDR2+FR3, FR3+CDR3+FR4, FR4, respectively, with overlapping regions at FR2, FR3, and FR4. Alternatively, three polynucleotides may also be used to cover the coding sequence of a complete variable domain by encoding at least part of: scheme 1) FR1+CDR1+FR2, FR2+CDR2+FR3, FR3+CDR3+FR4, with overlapping regions at FR2 and FR3; scheme 2) FR1, FR1+CDR1+FR2, FR2+CDR2+FR3+CDR3+FR4, with overlapping regions at FR1 and FR2; scheme 3) FR1, FR1+CDR1+FR2+CDR2+FR3, FR3+CDR3+FR4, with overlapping regions at FR1 and FR3; scheme 4) FR1+CDR1+FR2, FR2+CDR2+FR3+CDR3+FR4, FR4, with overlapping regions at FR2 and FR4; scheme 5) FR1+CDR1+FR2+FR3, FR3+CDR3+FR4, FR4, with overlapping regions at FR3 and FR4. In a further aspect, two polynucleotides may be designed for encoding the complete variable domain, with overlapping regions at FR1, FR2, FR3, or FR4 for different design choices, for example as encoding at least part of: scheme 1) FR1+CDR1+FR2, FR2+CDR2+FR3+CDR3+FR4; scheme 2) FR1+CDR1+FR2+CDR3+FR3, FR3+CDR3+FR4.

The polynucleotides designed as described above may be prepared by chemical synthesis or other methods such as enzyme-based synthesis. Recent advances in chemical synthesis, especially in automated solid-phase synthesis, have improved the yields and efficiency in the synthesis of larger oligonucleotides and reduced the considerable labor involved in their preparation and purification because of the necessity for chemical protection of the bases and the occurrence of side reactions during synthesis. A number of oligonucleotide synthesizers and services are available commercially. Coupling efficiencies >99.80% are now readily attainable

Followed the preparation of overlapping polynucleotides as described above, annealing of polynucleotides could be performed under any suitable conditions or using any suitable methods. “Annealing,” as used herein, refers to the formation of nucleotides which are at least partly double-stranded from single-stranded nucleotides. Different populations of polynucleotides designed to selectively hybridize mutually may be mixed under conditions that permit selective hybridization successively or simultaneously. Depending upon the desired application, high stringency hybridization conditions may be selected that will only allow hybridization between sequences that are completely complementary. In other embodiments, hybridization may occur under reduced stringency to allow for hybridization of nucleic acids comprising one or more mismatches with the primer sequences. For example, the polynucleotides to be annealed are mixed in adequate amounts and the resulting solution is heated to about 90° C.-100° C. for about 1 to 10 minutes, preferably from 1 to 4 minutes for denaturing of the polynucleotides. After this heating period the solution may be allowed to cool to room temperature, which is preferable for annealing of polynucleotides. Annealing can also be preformed by gradually decreasing temperature in a controlled manner (e.g. using a thermocyclyer), such as from 95° C. to 25° C. at the ramp of −1° C./min.

Once annealed, the double-stranded polynucleotide complex may be contacted with one or more agents that facilitate template-dependent nucleic acid synthesis to extend the strands at the end. The strand extension reaction may be performed using any suitable method. Generally it occurs in a buffered aqueous solution, preferably at a pH of 7-9, most preferably about 8. To the annealed mixture is added an appropriate agent for inducing or catalyzing the strand extension reaction, and the reaction is allowed to occur under conditions known in the art. The synthesis reaction may occur at from below room temperature up to a temperature above which the inducing agent no longer functions efficiently, for example, from about 10-60° C. for about 10 to 60 minutes. If DNA polymerase is used as inducing agent, the temperature is generally no greater than about 40° C.

The inducing agent may be any compound or system which will function to accomplish the strand extension, including enzymes, such as DNA polymerases. DNA polymerases may use a magnesium ion for catalytic activity. For example, a high fidelity polymerase without strand displacing activity, such as T4 DNA polymerase, may be preferred in certain aspects of the present invention for strand extension. Other suitable enzymes for this purpose include, for example, E. coli DNA polymerase I, Klenow fragment of E. coli DNA polymerase I, other available DNA polymerases, reverse transcriptase, and other enzymes, including heat-stable enzymes, which will facilitate combination of the nucleotides in the proper manner to form the primer extension products which are complementary to each nucleic acid strand.

Generally, the synthesis will be initiated at the 3′ end of each primer and proceed in the 5′ direction along the template strand, until synthesis terminates, producing molecules of different lengths. There may be inducing agents, however, which initiate synthesis at the 5′ end and proceed in the above direction, using the same process as described above. More specifically, conditions of this gap-filling reaction with T4 DNA polymerase were optimized as 500 μM for dNTP concentration, and incubation at 37° C. for 60 min followed by heat inactivation at 75° C. for 20 min in the presence of 10 mM EDTA.

For annealing with three or more different populations of polynucleotides, ligation may be involved for filling in the gaps between adjacent nucleotides after strand extension, which may be performed during or after strand extension. The newly synthesized strand and its complementary nucleic acid strand form a double-stranded molecule which can then be used in the succeeding steps of the process.

For example, the VH and/or VL-coding DNA homologs contained within the library produced by the above-described methods can be operatively linked to a vector for amplification and/or expression. In preferred embodiments, the VH and/or VL gene libraries are subjected to in-frame selection by first constructing C-terminal fusions to a reporter enzyme such as β-lactamase, followed by selection for resistance to an agent recognized by the reporter enzyme, for example ampicillin in the case of β-lactamase (Seehaus 1992; Lutz 2002; Rothe 2008). For example, the VH/Vκ selection vectors are constructed, and validation experiments with known VH clones suggest that these plasmids could be used to select for full-length and in-frame antibody variable domains efficiently. Conditions, such as concentrations of inducer (IPTG) and antibiotics (ampicillin), can be optimized to balance between efficient in-frame selection and ability to generate large number of transformants. The sizes of obtained libraries were estimated by spotting cells with serial dilutions, and results indicate that there were 3.7±0.3×10⁸ transformants for VH library, and 1.7±0.2×10⁹ for Vκ library.

In certain embodiments, the VH-coding and VL-coding DNA homologs of diverse libraries may be randomly combined in vitro for polycistronic expression from individual vectors. That is, a diverse population of double stranded DNA expression vectors is produced wherein each vector expresses, under the control of a single promoter, one VH-coding DNA homolog and one VL-coding DNA homolog, the diversity of the population being the result of different VH- and VL-coding DNA homolog combinations.

The resulting constructs may be then introduced into an appropriate host to provide amplification and/or expression of the VH- and/or VL-coding DNA homologs, either separately, in combination, or into expression vectors with suitable framework for full-length antibody expression. When co-expressed within the same organism, either on the same or the different vectors, a functionally active F_{V} is produced. When the VH and VL polypeptides are expressed in different organisms, the respective polypeptides are isolated and then combined in an appropriate medium to form a F_{V}. Cellular hosts into which a VH- and/or VL-coding DNA homolog-containing construct has been introduced are referred to herein as having been “transformed” or as “transformants”.

Successfully transformed cells, i.e., cells containing a VH- and/or VL-coding DNA operatively linked to a vector, can be identified by any suitable well known technique for detecting the binding of a receptor to a ligand or the presence of a polynucleotide coding for the receptor, preferably its active site. Preferred screening assays are those where the binding of ligand by the receptor produces a detectable signal, either directly or indirectly. Such signals include, for example, the production of a complex. In addition to directly assaying for the presence of a VH- and/or VL-coding DNA homolog, successful transformation can be confirmed by well known immunological methods, especially when the VH and/or VL polypeptides produced contain a preselected epitope. For example, samples of cells suspected of being transformed are assayed for the presence of the preselected epitope using an antibody against the epitope. Several different molecular selection strategies can be applied to antibody libraries prepared by the present methods, such as phage display, ribosome and mRNA display, yeast cell display (Hoogenboom 2005), and E-clonal technology using E. coli periplasmic space for antibody display.

In particular, the E-clonal platform technology may be preferred for screen of antibody libraries (U.S. 60/915,183, U.S. 60/982,652, U.S. Pat. No. 7,094,571, U.S. Pat. No. 5,866,344, U.S. Pat. No. 5,348,867, US 2007/0099267, US 2006/0029947, US 2005/0260736, US 2004/0058403, US 2007/0258954, US 2004/0072740, US 2003/0036092, all incorporated herein by reference). For example, IgG libraries could constructed and expressed in E. coli where they accumulate in the periplasmic space, between the inner (IM) and outer (OM) membranes of the bacterium. Cells are grown under conditions that ensure the optimal assembly of heavy and light chains into IgG. Within the E. coli periplasm, the IgG is captured on the surface of the inner membrane (IM). One preferred way for the capture of IgG molecules on the surface of the inner membrane is via coexpression of Protein A fused to a lipoprotein anchor sequence that tethers it stably to the inner membrane. This strategy is called Anchored Periplasmic Expression or APEx. Subsequently, the outer membrane (OM) is stripped from the cells by treatment with Tris-EDTA-lysozyme and thus the cells are converted to spheroplasts. Following incubation with fluorescently labeled antigen, spheroplasts displaying IgG that recognize the antigen become labeled and are isolated by high throughput flow cytometry or by fluorescently activated cell sorting (FACS). Antibodies with sub-nanomolar affinities could be obtained from IgG libraries derived from synthetic libraries where sequence diversity had been introduced by complete randomization of the CDRs using the present methods.

### IV. Antibody Variable Domains

Certain aspects of the invention provide methods for generating a library of antibody variable domains or variable domain-coding sequences. A diverse library of antibody variable domains is useful to identify novel antigen binding molecules having high affinity or specificity. Generating a library with antibody variable domains with a high level of diversity and that are structurally stable allows for the isolation of high affinity binders and for antibody variable domains that can more readily be produced in cell culture on a large scale. The present invention is based on the showing that regions of an antibody variable domain that form the antigen binding pocket could have the desired diversity introduced by the novel methods provided.

Antibodies are globular plasma proteins (˜150 kDa) that are also known as immunoglobulins. They have sugar chains added to some of their amino acid residues. In other words, antibodies are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds. Each chain is composed of structural domains called Ig domains. These domains contain about 70-110 amino acids and are classified into different categories (for example, variable or IgV, and constant or IgC) according to their size and function. They have a characteristic immunoglobulin fold in which two beta sheets create a “sandwich” shape, held together by interactions between conserved cysteines and other charged amino acids.

There are five types of mammalian Ig heavy chain denoted by the Greek letters: α, δ, ε, γ, and μ. The type of heavy chain present defines the class of antibody; these chains are found in IgA, IgD, IgE, IgG, and IgM antibodies, respectively. Distinct heavy chains differ in size and composition; Ig heavy chains α and γ contain approximately 450 amino acids, while μ and ε have approximately 550 amino acids.

Each heavy chain has two regions, the constant region and the variable region. The constant region is identical in all antibodies of the same isotype, but differs in antibodies of different isotypes. Heavy chains γ, α and δ have a constant region composed of three tandem (in a line) Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals there are two types of Immunoglobulin light chain, which are called lambda (λ) and kappa (κ). A light chain has two successive domains: one constant domain and one variable domain. The approximate length of a light chain is 211 to 217 amino acids. Each antibody contains two light chains that are always identical; only one type of light chain, κ or λ, is present per antibody in mammals.

The fragment antigen-binding (Fab fragment) is a region on an antibody that binds to antigens. It is composed of one constant and one variable domain of each of the heavy and the light chain. These domains shape the paratope—the antigen-binding site—at the amino terminal end of the monomer.

The two variable domains bind the epitope on their specific antigens. The variable domain is also referred to as the F_{V} region and is the most important region for binding to antigens. More specifically variable loops, three each on the light (V_{L}) and heavy (V_{H}) chains are responsible for binding to the antigen. These loops are referred to as the Complementarity Determining Regions (CDRs).

A complementarity determining region (CDR) is a short amino acid sequence found in the variable domains of antigen receptor (e.g. immunoglobulin and T cell receptor) proteins that complements an antigen and therefore provides the receptor with its specificity for that particular antigen. CDRs are supported within the variable domains by conserved framework regions (FRs).

Each polypeptide chain of an antigen receptor contains three CDRs (CDR1, CDR2 and CDR3). Since the antigen receptors are typically composed of two polypeptide chains, there are six CDRs for each antigen receptor that can come into contact with the antigen (each heavy and light chain contains three CDRs), twelve CDRs on a single antibody molecule and sixty CDRs on a pentameric IgM molecule. Since most sequence variation associated with immunoglobulins and T cell receptors are found in the CDRs, these regions are sometimes referred to as hypervariable domains. Among these, CDR3 shows the greatest variability as it is encoded by a recombination of the VJ (VDJ in the case of heavy chain) regions.

For generating a library of antibody variable domains, certain aspects of the present invention provide methods of designing diversity of antibody complementarity determining regions (CDRs). Specifically, the diversity of synthetic antibody libraries could be generated by introducing varied codons for coding one to six of the complementary determining regions (CDRs) on VH and/or VL. The diversity could be based on mimicking naturally occurring antibody diversity.

### V. Diversity

Certain aspects of the present invention provide methods to create antibody variable domain libraries with extensive diversity, for example, to mimic the natural process of genetic recombination and affinity maturation of antibodies. Specifically, diversity of antibody variable domains could be introduced by introducing a selection of amino acids with considerable prevalence in the nature into or randomizing certain positions of the complementary determining regions (CDRs) on VH and/or VL. For example, a natural human antibody database could be analyzed to identify naturally occurring variations in different positions of CDRs and the frequency of those variations. A preferred example of diversity design is described in Example 1.

In nature, the mammalian immune system has evolved unique genetic mechanisms that enable it to generate an almost unlimited number of different light and heavy chains in a remarkably economical way, by combinatorially joining chromosomally separated gene segments prior to transcription. Each type of immunoglobulin (Ig) chain (i.e., κ light, λ light, and heavy) is synthesized by combinatorial assembly of DNA sequences selected from two or more families of gene segments, to produce a single polypeptide chain. Specifically, the heavy chains and light chains each consist of a variable domain and a constant (C) domain. The variable domains of the heavy chains are encoded by DNA sequences assembled from three families of gene segments: variable (IGHV), joining (IGHJ) and diversity (IGHD). The variable domains of light chains are encoded by DNA sequences assembled from two families of gene segments for each of the kappa and lambda light chains: variable (IGLV) and joining (IGLJ). Each variable domain (heavy and light) is also recombined with a constant domain, to produce a full-length immunoglobulin chain.

While combinatorial assembly of the V, D and J gene segments make a substantial contribution to antibody variable region diversity, further diversity is introduced in vivo, at the pre-B cell stage, via imprecise joining of these gene segments and the introduction of non-templated nucleotides at the junctions between the gene segments.

After a B cell recognizes an antigen, it is induced to proliferate. During proliferation, the B cell receptor locus undergoes an extremely high rate of somatic mutation that is far greater than the normal rate of genomic mutation. The mutations that occur are primarily localized to the Ig variable domains and comprise substitutions, insertions and deletions. This somatic hypermutation enables the production of B cells that express antibodies possessing enhanced affinity toward an antigen. Such antigen-driven somatic hypermutation fine-tunes antibody responses to a given antigen.

To introduce diversity mimicking those natural processes or even maximizing the potential useful diversity, polynucleotides with diversified regions could be prepared, such as through synthesis.

### VI. Polynucleotide Preparation

The term “polynucleotide” as used herein in reference to primers, probes and nucleic acid fragments or segments to be synthesized by primer extension is defined as a molecule comprised of two or more deoxyribonucleotides or ribonucleotides, preferably more than 75. Its exact size will depend on many factors, which in turn depends on the ultimate conditions of use. A polynucleotide whether purified from a nucleic acid restriction digest or produced synthetically, may be used as a point of initiation of synthesis when placed under conditions in which synthesis of a strand extension product which is complementary to a nucleic acid strand is induced, i.e., in the presence of nucleotides and an agent for strand extension such as DNA polymerase, reverse transcriptase and the like, and at a suitable temperature and pH. The polynucleotide is preferably single-stranded for maximum efficiency, but may alternatively be double-stranded. If double-stranded, the polynucleotide is first treated to separate its strands before being used to prepare extension products. Preferably, the polynucleotide is a polydeoxyribonucleotide. The polynucleotide must be sufficiently long to prime the synthesis of extension products in the presence of the agents for strand extension. The exact lengths of the polynucleotides will depend on many factors, including diversity design considerations, temperature and the source of polynucleotides. For example, in the context of this invention, a polynucleotide typically contains 50 to 140 or more nucleotides, although it can contain fewer nucleotides. Short primer molecules generally require cooler temperatures to form sufficiently stable hybrid complexes with template.

Polynucleotides can be prepared using any suitable method, such as, for example, the phosphotriester on phosphodiester methods see Narang et al. (1979); U.S. Pat. No. 4,356,270; and Brown et al. (1979). In certain embodiments, polynucleotides may also have contiguous or adjacent to their termini a nucleotide sequence defining an endonuclease restriction site for insertion into vectors.

The polynucleotides used herein are selected to be complementary, at least in part, among different populations, such as two, three, four, or more different populations, preferably sufficient to cover a complete or a majority of an antibody variable domain when annealed altogether. This means that the polynucleotides could be sufficiently complementary to nonrandomly hybridize with its respective strand. The complementary sequences, i.e., the overlapping regions, may encode any portions of antibody variable domains, preferably parts of FR regions or CDR2, while at least part of non-overlapping regions are diversified, such as CDR3.

In certain aspects degenerate polynucleotides are used. These are actually mixtures of similar, but not identical, polynucleotides. They may be convenient to introduce diversity into antibody variable domains. Degenerate polynucleotides are widely used and extremely useful in the field of microbial ecology. They allow for the amplification of genes from thus far uncultivated microorganisms or allow the recovery of genes from organisms where genomic information is not available. Usually, degenerate polynucleotides are designed by aligning gene sequencing found in GenBank. Differences among sequences are accounted for by using IUPAC degeneracies for individual bases. Degenerate polynucleotides are then synthesized as a mixture of polynucleotides corresponding to all permutations.

### VII. Nucleic Acid-Based Expression Systems

Nucleic acid-based expression systems may find use, in certain embodiments of the invention, for the expression of diversified antibody variable domains. For example, one embodiment of the invention involves transformation of bacteria with the coding sequences for a diversified variable domain.

B. Methods of Nucleic Acid Delivery

Certain aspects of the invention may comprise delivery of nucleic acids to target cells (e.g., gram negative bacteria). For example, bacterial host cells may be transformed with nucleic acids encoding antibody variable domains. In particular embodiments of the invention, it may be desired to target the expression to the periplasm of the bacteria. Transformation of eukaryotic host cells may similarly find use in the expression of various candidate molecules identified as capable of binding a target ligand.

Suitable methods for nucleic acid delivery for transformation of a cell are believed to include virtually any method by which a nucleic acid (e.g., DNA) can be introduced into such a cell, or even an organelle thereof. Such methods include, but are not limited to, direct delivery of DNA such as by injection (U.S. Pat. Nos. 5,994,624, 5,981,274, 5,945,100, 5,780,448, 5,736,524, 5,702,932, 5,656,610, 5,589,466 and 5,580,859, each incorporated herein by reference), including microinjection (Harland and Weintraub, 1985; U.S. Pat. No. 5,789,215, incorporated herein by reference); by electroporation (U.S. Pat. No. 5,384,253, incorporated herein by reference); by calcium phosphate precipitation (Graham and Van Der Eb, 1973; Chen and Okayama, 1987; Rippe et al., 1990); by using DEAE-dextran followed by polyethylene glycol (Gopal, 1985); by direct sonic loading (Fechheimer et al., 1987); by liposome mediated transfection (Nicolau and Sene, 1982; Fraley et al., 1979; Nicolau et al., 1987; Wong et al., 1980; Kaneda et al., 1989; Kato et al., 1991); by microprojectile bombardment (PCT Application Nos. WO 94/09699 and 95/06128; U.S. Pat. Nos. 5,610,042; 5,322,783, 5,563,055, 5,550,318, 5,538,877 and 5,538,880, and each incorporated herein by reference); or by agitation with silicon carbide fibers (Kaeppler et al., 1990; U.S. Pat. Nos. 5,302,523 and 5,464,765, each incorporated herein by reference); by desiccation/inhibition-mediated DNA uptake (Potrykus et al., 1985). Through the application of techniques such as these, cells may be stably or transiently transformed.

1. Electroporation

In certain embodiments of the present invention, a nucleic acid is introduced into a cell via electroporation. Electroporation involves the exposure of a suspension of cells and DNA to a high-voltage electric discharge. In some variants of this method, certain cell wall-degrading enzymes, such as pectin-degrading enzymes, are employed to render the target recipient cells more susceptible to transformation by electroporation than untreated cells (U.S. Pat. No. 5,384,253, incorporated herein by reference). Alternatively, recipient cells can be made more susceptible to transformation by mechanical wounding.

2. Calcium Phosphate

In other embodiments of the present invention, a nucleic acid is introduced to the cells using calcium phosphate precipitation.

B. Vectors

Vectors may find use with the current invention, for example, in the transformation of a host cell with a nucleic acid sequence encoding an antibody variable domain. In one embodiment of the invention, an entire heterogeneous “library” of nucleic acid sequences encoding target polypeptides may be introduced into a population of bacteria, thereby allowing screening of the entire library. The term “vector” is used to refer to a carrier nucleic acid molecule into which a nucleic acid sequence can be inserted for introduction into a cell where it can be replicated. A nucleic acid sequence can be “exogenous,” or “heterologous”, which means that it is foreign to the cell into which the vector is being introduced or that the sequence is homologous to a sequence in the cell but in a position within the host cell nucleic acid in which the sequence is ordinarily not found. Vectors include plasmids, cosmids and viruses (e.g., bacteriophage). One of skill in the art may construct a vector through standard recombinant techniques, which are described in Maniatis et al., 1988 and Ausubel et al., 1994, both of which references are incorporated herein by reference.

The term “expression vector” refers to a vector containing a nucleic acid sequence coding for at least part of a gene product capable of being transcribed. In some cases, RNA molecules are then translated into a protein, polypeptide, or peptide. Expression vectors can contain a variety of “control sequences,” which refer to nucleic acid sequences necessary for the transcription and possibly translation of an operably linked coding sequence in a particular host organism. In addition to control sequences that govern transcription and translation, vectors and expression vectors may contain nucleic acid sequences that serve other functions as well and are described infra.

1. Promoters and Enhancers

A “promoter” is a control sequence that is a region of a nucleic acid sequence at which initiation and rate of transcription are controlled. It may contain genetic elements at which regulatory proteins and molecules may bind such as RNA polymerase and other transcription factors. The phrases “operatively positioned,” “operatively linked,” “under control,” and “under transcriptional control” mean that a promoter is in a correct functional location and/or orientation in relation to a nucleic acid sequence to control transcriptional initiation and/or expression of that sequence. A promoter may or may not be used in conjunction with an “enhancer,” which refers to a cis-acting regulatory sequence involved in the transcriptional activation of a nucleic acid sequence.

A promoter may be one naturally associated with a gene or sequence, as may be obtained by isolating the 5′ non-coding sequences located upstream of the coding segment and/or exon. Such a promoter can be referred to as “endogenous.” Similarly, an enhancer may be one naturally associated with a nucleic acid sequence, located either downstream or upstream of that sequence. Alternatively, certain advantages will be gained by positioning the coding nucleic acid segment under the control of a recombinant or heterologous promoter, which refers to a promoter that is not normally associated with a nucleic acid sequence in its natural environment. A recombinant or heterologous enhancer refers also to an enhancer not normally associated with a nucleic acid sequence in its natural environment. Such promoters or enhancers may include promoters or enhancers of other genes, and promoters or enhancers isolated from any other prokaryotic cell, and promoters or enhancers not “naturally occurring,” i.e., containing different elements of different transcriptional regulatory regions, and/or mutations that alter expression. In addition to producing nucleic acid sequences of promoters and enhancers synthetically, sequences may be produced using recombinant cloning and/or nucleic acid amplification technology, including PCR™, in connection with the compositions disclosed herein (see U.S. Pat. No. 4,683,202, U.S. Pat. No. 5,928,906, each incorporated herein by reference).

Naturally, it will be important to employ a promoter and/or enhancer that effectively directs the expression of the DNA segment in the cell type chosen for expression. One example of such promoter that may be used with the invention is the E. coli arabinose or T7 promoter. Those of skill in the art of molecular biology generally are familiar with the use of promoters, enhancers, and cell type combinations for protein expression, for example, see Sambrook et al. (1989), incorporated herein by reference. The promoters employed may be constitutive, tissue-specific, inducible, and/or useful under the appropriate conditions to direct high level expression of the introduced DNA segment, such as is advantageous in the large-scale production of recombinant proteins and/or peptides. The promoter may be heterologous or endogenous.

2. Initiation Signals and Internal Ribosome Binding Sites

A specific initiation signal also may be required for efficient translation of coding sequences. These signals include the ATG initiation codon or adjacent sequences. Exogenous translational control signals, including the ATG initiation codon, may need to be provided. One of ordinary skill in the art would readily be capable of determining this and providing the necessary signals. It is well known that the initiation codon must be “in-frame” with the reading frame of the desired coding sequence to ensure translation of the entire insert. The exogenous translational control signals and initiation codons can be either natural or synthetic. The efficiency of expression may be enhanced by the inclusion of appropriate transcription enhancer elements.

3. Multiple Cloning Sites

Vectors can include a multiple cloning site (MCS), which is a nucleic acid region that contains multiple restriction enzyme sites, any of which can be used in conjunction with standard recombinant technology to digest the vector (see Carbonelli et al., 1999, Levenson et al., 1998, and Cocea, 1997, incorporated herein by reference.) “Restriction enzyme digestion” refers to catalytic cleavage of a nucleic acid molecule with an enzyme that functions only at specific locations in a nucleic acid molecule. Many of these restriction enzymes are commercially available. Use of such enzymes is understood by those of skill in the art. Frequently, a vector is linearized or fragmented using a restriction enzyme that cuts within the MCS to enable exogenous sequences to be ligated to the vector. “Ligation” refers to the process of forming phosphodiester bonds between two nucleic acid fragments, which may or may not be contiguous with each other. Techniques involving restriction enzymes and ligation reactions are well known to those of skill in the art of recombinant technology.

4. Termination Signals

The vectors or constructs prepared in accordance with the present invention will generally comprise at least one termination signal. A “termination signal” or “terminator” is comprised of the DNA sequences involved in specific termination of an RNA transcript by an RNA polymerase. Thus, in certain embodiments, a termination signal that ends the production of an RNA transcript is contemplated. A terminator may be necessary in vivo to achieve desirable message levels.

Terminators contemplated for use in the invention include any known terminator of transcription described herein or known to one of ordinary skill in the art, including but not limited to, for example, rho dependent or rho independent terminators. In certain embodiments, the termination signal may be a lack of transcribable or translatable sequence, such as due to a sequence truncation.

5. Origins of Replication

In order to propagate a vector in a host cell, it may contain one or more origins of replication sites (often termed “ori”), which is a specific nucleic acid sequence at which replication is initiated.

6. Selectable and Screenable Markers

In certain embodiments of the invention, cells containing a nucleic acid construct of the present invention may be identified in vitro or in vivo by including a marker in the expression vector. Such markers would confer an identifiable change to the cell permitting easy identification of cells containing the expression vector. Generally, a selectable marker is one that confers a property that allows for selection. A positive selectable marker is one in which the presence of the marker allows for its selection, while a negative selectable marker is one in which its presence prevents its selection. An example of a positive selectable marker is a drug resistance marker.

Usually the inclusion of a drug selection marker aids in the cloning and identification of transformants, for example, genes that confer resistance to neomycin, puromycin, hygromycin, DHFR, GPT, zeocin and histidinol are useful selectable markers. In addition to markers conferring a phenotype that allows for the discrimination of transformants based on the implementation of conditions, other types of markers including screenable markers such as GFP, whose basis is colorimetric analysis, are also contemplated. Alternatively, screenable enzymes such as chloramphenicol acetyltransferase (CAT) may be utilized. One of skill in the art would also know how to employ immunologic markers, possibly in conjunction with FACS analysis. The marker used is not believed to be important, so long as it is capable of being expressed simultaneously with the nucleic acid encoding a gene product. Further examples of selectable and screenable markers are well known to one of skill in the art.

C. Host Cells

In the context of expressing a heterologous nucleic acid sequence, “host cell” refers to a prokaryotic cell, and it includes any transformable organism that is capable of replicating a vector and/or expressing a heterologous gene encoded by a vector. A host cell can, and has been, used as a recipient for vectors. A host cell may be “transfected” or “transformed,” which refers to a process by which exogenous nucleic acid is transferred or introduced into the host cell. A transformed cell includes the primary subject cell and its progeny.

In particular embodiments of the invention, a host cell is a Gram negative bacterial cell. These bacteria are suited for use with the invention in that they posses a periplasmic space between the inner and outer membrane and, particularly, the aforementioned inner membrane between the periplasm and cytoplasm, which is also known as the cytoplasmic membrane. As such, any other cell with such a periplasmic space could be used in accordance with the invention. Examples of Gram negative bacteria that may find use with the invention may include, but are not limited to, E. coli, Pseudomonas aeruginosa, Vibrio cholera, Salmonella typhimurium, Shigella flexneri, Haemophilus influenza, Bordotella pertussi, Erwinia amylovora, Rhizobium sp. The Gram negative bacterial cell may be still further defined as bacterial cell which has been transformed with the coding sequence of a fusion polypeptide comprising a candidate binding polypeptide capable of binding a selected ligand. The polypeptide is anchored to the outer face of the cytoplasmic membrane, facing the periplasmic space, and may comprise an antibody coding sequence or another sequence. One means for expression of the polypeptide is by attaching a leader sequence to the polypeptide capable of causing such directing.

Numerous prokaryotic cell lines and cultures are available for use as a host cell, and they can be obtained through the American Type Culture Collection (ATCC), which is an organization that serves as an archive for living cultures and genetic materials (www.atcc.org). An appropriate host can be determined by one of skill in the art based on the vector backbone and the desired result. A plasmid or cosmid, for example, can be introduced into a prokaryote host cell for replication of many vectors. Bacterial cells used as host cells for vector replication and/or expression include DH5α, JM109, and KC8, as well as a number of commercially available bacterial hosts such as SURE® Competent Cells and SOLOPACK™ Gold Cells (STRATAGENE®, La Jolla). Alternatively, bacterial cells such as E. coli LE392 could be used as host cells for bacteriophage.

Many host cells from various cell types and organisms are available and would be known to one of skill in the art. Similarly, a viral vector may be used in conjunction with a prokaryotic host cell, particularly one that is permissive for replication or expression of the vector. Some vectors may employ control sequences that allow it to be replicated and/or expressed in both prokaryotic and eukaryotic cells. One of skill in the art would further understand the conditions under which to incubate all of the above described host cells to maintain them and to permit replication of a vector. Also understood and known are techniques and conditions that would allow large-scale production of vectors, as well as production of the nucleic acids encoded by vectors and their cognate polypeptides, proteins, or peptides.

D. Expression Systems

Numerous expression systems exist that comprise at least a part or all of the compositions discussed above. Such systems could be used, for example, for the production of a polypeptide product identified in accordance with the invention as capable of binding a particular ligand. Prokaryote-based systems can be employed for use with the present invention to produce nucleic acid sequences, or their cognate polypeptides, proteins and peptides. Many such systems are commercially and widely available. Other examples of expression systems comprise of vectors containing a strong prokaryotic promoter such as T7, Tac, Trc, BAD, lambda pL, Tetracycline or Lac promoters, the pET Expression System and an E. coli expression system.

### VIII. VH- and/or VL-Coding Gene Libraries

The present invention contemplates a gene library, preferably produced by annealing and strand extension reactions as described herein, containing at least about 10⁸, preferably at least about 10⁹ different VH- and/or VL-coding DNA homologs. The homologs are preferably in an isolated form, that is, substantially free of materials such as, for example, strand extension reaction agents and/or substrates, genomic DNA segments, and the like.

In preferred embodiments, a substantial portion of the homologs present in the library are operatively linked to a vector, preferably operatively linked for expression to an expression vector.

Preferably, the homologs are present in a medium suitable for in vitro manipulation, such as water, water containing buffering salts, and the like. The medium should be compatible with maintaining the biological activity of the homologs. In addition, the homologs should be present at a concentration sufficient to allow transformation of a host cell compatible therewith at reasonable frequencies. It is further preferred that the homologs be present in compatible host cells transformed therewith.

### IX. Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Design of Antibody Complementarity Determining Regions (CDRs) Amino Acid Diversification

The antibody variable domain germlines, VHIII (DP47) and VHIII (DPK22) were used as the framework to construct synthetic antibody libraries. DP47 and DPK22 were chosen because (1) they are highly prevalent among all human antibody germlines (i.e. 12% and 29% respectively) (Knappik 2000); and (2) it has been demonstrated that these frameworks are well expressed in bacteria (Ewert 2003). The diversity of synthetic antibody libraries was generated by randomizing all the six complementary determining regions (CDRs) on both VH and Vκ. Firstly, the diversity occurring in natural human antibodies were analyzed using the KabatMan antibody database (http://www.bioinf.org.uk/abs/kabatman.html). This database has sequences of 6014 light chains and 7895 heavy chains, and it also provides a convenient query language to survey the data (Martin 1996). For example, there are 1626 human VHIII antibody sequences with length of CDR-H1 equal to 5 in the database. Out of these 1626 sequences, 745 have Ser at position H31 within CDR-H1, and 268 have Asn, 218 have Asp, 149 have Thr, 137 have Gly, 43 have Arg, etc. for the same position. Using this method, the occurrence frequency (%) of 20 amino acids in each position was analyzed for CDR-L1, L2, H1, H2, and position L90, L92, L93 in CDR-L3 and H94 in CDR-H3. These analyses results are listed in Table 1 and Table 2, for Vκ and VH respectively. Only amino acids with considerable prevalence (such as >1%) are listed.

TABLE 1
Diversity analysis and design of CDR-L1, CDR-L2 and CDR-L3.

| | | | Diversity design | | | |
|---|---|---|---|---|---|---|
| CDR | | Diversity analysis | | Residues | | Poly- |
| (length) | Position | (Prevalence in natural antibodies%) | Codon | encoded | Coverage % | nucleotides |
| L1 (11) | L29 | V (60); I (37) | RTT | VI | 97 | VL2a |
| | L30 | S (76); G (13); N (5); R (2); T (1) | RGC | SG | 89 | |
| | L31 | S (74); N (10); T (7); Y (1); G | AVC | SNT | 90 | |
| | | (1); R (1); K (1); D (1) | | | | |
| | L32 | Y (59); N (32); S (5); F (3) | WAT | YN | 90 | |
| L1 (12) | L28 | V (87); I (8) | RTT | VI | 94 | VL2b |
| | L29 | S (87); T (3); N (2); R (2); D (2) | AVC | STN | 93 | |
| | L30 | S (82); N (9); R (6); G (2); A (2) | ARC | SN | 91 | |
| | L31 | S (69); N (14); T (9); G (2); A (2); | AVC | SNT | 92 | |
| | | R (2) | | | | |
| L2 | L50 | G (45); D (39); A (12); S (3); Y | GVC | GDA | 90 | VL3 |
| | | (2); E (1) | | | | |
| | L51 | A (88); T (8); V (1) | RCC | AT | 96 | |
| | L53 | S (37); N (37); T (18); K (4); R | AVH | SNTKR* | 96 | |
| | | (1) | | | | |
| L3** | L90 | Q (94); H (6) | CAD | QH*** | 99 | VL4 |
| | L91 | Xaa | NNS | Xaa | / | |
| | L92 | G (49); S (30); N (9); D (3); E | RRC | GDND | 91 | |
| | | (3); R (2) | | | | |
| | L93 | S (37); N (31); T (10); A (5); G | RVC | SNTAGD | 86 | |
| | | (2); D (2) | | | | |
| | L94 | Xaa | NNS | Xaa | / | |
| | L96 | Xaa | NNS | Xaa | / | |

*The designed molar ratio of Ser:Asn:Thr:Lys:Arg = 3:2:2:1:1.
**L95 = P and L97 = T.
***The designed molar ratio of Gln:His = 2:1.
IUB code:
B = C/G/T,
D = A/G/T,
H = A/C/T,
K = G/T,
M = A/C,
N = A/C/G/T,
R = A/G,
S = G/C,
V = A/C/G,
W = A/T,
Y = C/T.

TABLE 2
Diversity analysis and design of CDR-H1, CDR-H2 and CDR-H3.

| | | | Diversity design | | | |
|---|---|---|---|---|---|---|
| CDR | | Diversity analysis | | Residues | | Poly- |
| (length) | Position | (Prevalence in natural antibodies %) | Codon | encoded | Coverage % | nucleotides |
| H1 | H31 | S (46); N (16); D (13); T (9); G | RVC | SNDTGA | 94 | VH2 |
| | | (8); R (3); A (1); K (1) | | | | |
| | H32 | Y (74); A (6); S (5); F (4); H (3); | KMC | YASD | 86 | |
| | | N (3); V (2); D (1) | | | | |
| | H33 | A (31); W (19); Y (16); G (15); S | KSG | AWGS | 70 | |
| | | (6); E (4); D (3) T (2) | | | | |
| | H35 | S (41); H (31); N (16); T (6); Y (1) | HMT | SHNTY P | 96 | |
| H2 | H50 | V (19); A (16); Y (13); N (11); G | DHC | VAYNSTI | 74 | VH3 |
| | | (9); S (8); L (5); W (4); T (3); R | | F D | | |
| | | (3); I (2); F (2); K (1) | | | | |
| | H52 | S (60); K (11); N (9); W (6); T (3); | ARH | SKNR* | 83 | |
| | | R (3); Y (2) | | | | |
| | H52a | G (21); Y (20); S (18); Q (9); P | NMT | YSPNADT | 56 | |
| | | (5); N (4); W (4); F (3); A (3); D | | H | | |
| | | (2); T (2); E (2); R (2); H (1); K | | | | |
| | | (1) | | | | |
| | H53 | S (34); D (39); N (10); G (8); R | RRT | SDNG | 91 | |
| | | (3); T (1); Y (1); H (1) | | | | |
| | H54 | G (75); S (16) | RGC | GS | 90 | |
| | H55 | S (38); G (32); T (8); D (7); N (3); | RRC | SGDN | 81 | |
| | | A (2); E (1) | | | | |
| | H56 | S (26); N (19); T (15); E (10); Y | WMC | SNTY | 67 | |
| | | (7); D (4); G (4); K (2); R (2); A | | | | |
| | | (1); Q (1) | | | | |
| | H57 | T (38); K (34); I (19); R (2) | AHA | TKI | 90 | |
| | H58 | Y (68); F (5); S (4); H (4); T (1); R | TWT | YF | 73 | |
| | | (1) | | | | |
| H3 (9-12) | H94 | R (56); K (22); T (9) | ARA | RK | 78 | VH4a-d |
| H3 (12) | H95- | (Xaa)₉ | (NNS)₉ | (Xaa)₉ | / | VH4a |
| | 100c | | | | | |
| H3 (11) | H95- | (Xaa)₈ | (NNS)₈ | (Xaa)₈ | / | VH4b |
| | 100b | | | | | |
| H3 (10) | H95- | (Xaa)₇ | (NNS)₇ | (Xaa)₇ | / | VH4c |
| | 100a | | | | | |
| H3 (9) | H95- | (Xaa)₆ | (NNS)₆ | (Xaa)₆ | / | VH4d |
| | 100 | | | | | |

*The designed molar ratio of Ser:Lys:Asn:Arg = 2:2:1:1.
IUB code:
B = C/G/T,
D = A/G/T,
H = A/C/T,
K = G/T,
M = A/C,
N = A/C/G/T,
R = A/G,
S = G/C,
V = A/C/G,
W = A/T,
Y = C/T.

Degenerate codons were designed for each residue position, to mimic the natural occurring diversity and therefore, introduce randomization into CDRs. It was attempted to cover, as much as possible, all the highly frequently occurring residues, while avoiding codons for stop or cysteine, which would generate truncated antibody fragment or disturb disulfide bond formation, respectively. The designed degenerate codons for each position, and their amino acid coverage are shown on the right panels of Table 1 and Table 2 using the IUB code (B=C/G/T, D=A/G/T, H=A/C/T, K=G/T, M=A/C, N=A/C/G/T, R=A/G, S=G/C, V=A/C/G, W=A/T, Y=C/T). For CDR-L3, position L95 and L97 are set to be Pro and Thr, and L91, L94, and L96 were designed to be NNS to encode all the 20 amino acids. For CDR-H3, the position H100d, H101, H102 were set to be Phe, Asp, Tyr, and NNS codons were introduced to positions H95-H100c.

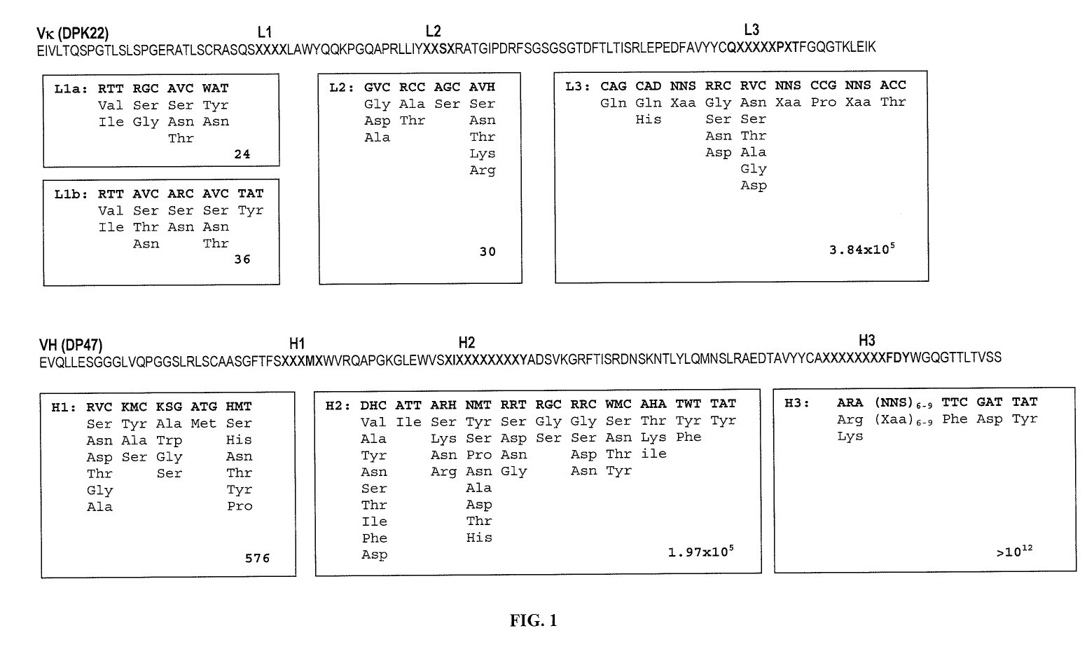

Statistical studies suggest a strong correlation between the classes of antigens and their antibody binding site topographies, which are especially derived from the length of CDR-H3 (Collis 2003). Longer CDR-H3 loops are associated with a flat antigen binding site and thus tend to favor large antigens; while shorter loops give concave or grooved binding surfaces, and favor smaller antigens. Collis (2003) analyzed 417 human antibodies and found that, for protein antigens, the mean length of CDR-H3 is 12.86 amino acids, while this number drops to 10.17 for haptens. Therefore, to provide binding capacity for a broad range of antigens, the synthetic library includes CDR-H3 having 9-12 amino acids. These CDR-H3 regions with different length were encoded by 4 individual polynucleotides (VH4a/b/c/d), having 6, 7, 8, and 9 NNS codons respectively. The entire sequences of VH and Vκ are demonstrated in FIG. 1, including FRs and CDRs, showing designed degenerate codons and their theoretical diversities. Total designed diversity is 6.9×10⁸ for Vκ, and greater than 10¹⁷ for V_{H}.

As shown in the right panels of Table 1 and Table 2, the degenerate codons employed allow high coverage for all the positions in CDR-L1, L2, L3, with average coverage equal to 92%. For the majority of positions in VH, the coverage is greater than 80%. Only two positions, H52a and H56, have relatively low coverage (i.e. 56% and 67%), due to the restriction of using genetic codon degeneracies. Diversity can be expanded or refined either using an NNS codon scheme (which however, will introduce unwanted stop codons and cysteine residues), multiple polynucleotides encoding CDR-H2 or finally polynucleotides synthesized using trinucleotides. Either method will increase the complexity of the design and more important, considering the theoretical size of VH library is greater than 10¹⁷, which is several magnitudes exceeding the applicable capacity, it is not essentially necessary to improve the coverage at these two positions.

### Example 2

### Design and Synthesis of Polynucleotides

Codon usage of the framework regions (FRs) was optimized for E. coli expression by using the web server Optimizer (http://genomes.urv.es/OPTIMIZER/) (Puigb, 2007). Codon optimized sequences of VH/Vκ genes were split into 4 sections (or 4 polynucleotides s), each between 90-140 bases in length. Upon annealing of the 4 polynucleotides they form overlap segments located in FRs, while leave the CDRs which are encoded as “gaps” to be filled following polymerization. Specifically, the polynucleotides VH1/Vκ1 encode for FR1, and polynucleotides VH/Vκ 2, 3, and 4 encode for CDR1, 2, 3 respectively, with the overlap segments at FR1, FR2, and FR3 with adjacent polynucleotides. In this design, two polynucleotides Vκ2a/b were used to encode CDR-L1 having different length (11 or 12 amino acids for CDR-L1), and similarly, 4 polynucleotides VH4a/b/c/d were used for CDR-H3 with 9, 10, 11, and 12 amino acids. The length and location of overlap segments between polynucleotides were fine-tuned to make the annealing sequences having same melting temperatures (˜58° C.). 12 polynucleotides (5 for Vκ, and 7 for VH) were designed and their sequences are listed in Table 3. These polynucleotides were synthesized commercially by Integrated DNA Technology (IDT). 5 polynucleotides VH2, VH3, Vκ2a/b, Vκ3 were 5′ phosphorylated, making them ready for ligation. These polynucleotides were PAGE purified (usually yield of ˜2 nmol), dissolved in ddH₂O to the final concentration of 20 μM, and stored at −20° C., or used for gene assembly.

TABLE 3
Sequences of polynucleotide primers

| | CDR | Sequence | bp | Modif. | SEQ ID No: |
|---|---|---|---|---|---|
| Vκ1 | | CCAGCCGGCCATGGCGGAAATCGTTCTGA | 93 | | 2 |
| | | CCCAGTCTCCGGGTACCCTGTCTCTGTCTC | | | |
| | | CGGGTGAACGTG | | | |
| | | CGACCCTGTCTTGCCGTGCCAG | | | |
| Vκ2a | L1 | CGTAGATCAGCAGACGCGGCGCCTGACCC | 90 | 5′-ph | 3 |
| | (11) | GGTTTCTGCTGGTACCACGCCAGATWGBT | | | |
| | | GCYAAYGCTCTGG | | | |
| | | CTGGCACGGCAAGACAGGG | | | |
| Vκ2b | L1 | CGTAGATCAGCAGACGCGGCGCCTGACCC | 93 | 5′-ph | 4 |
| | (12) | GGTTTCTGCTGGTACCACGCCAGATAGBTG | | | |
| | | YTGBTAAYGCTCT | | | |
| | | GGCTGGCACGGCAAGACAGGG | | | |
| Vκ3 | L2 | GCCGCGTCTGCTGATCTACGVCRCCAGCAV | 121 | 5′-ph | 5 |
| | | HCGTGCGACCGGTATCCCGGACCGTTTCTC | | | |
| | | TGGTTCTGGTTC | | | |
| | | TGGTACCGACTTCACCCTGACCATCTCTCG | | | |
| | | TCTGGAACCGGAAGACTTC | | | |
| Vκ4 | L3 | GACAGATGGTGCGGCCGCGGTACGTTTGA | 119 | | 6 |
| | | TTTCCAGTTTGGTACCCTGACCGAAGGTSN | | | |
| | | NCGGSNNGBYGYY | | | |
| | | SNNHTGCTGGCAGTAGTAAACCGCGAAGT | | | |
| | | CTTCCGGTTCCAGACGAG | | | |
| VH1 | | GCGTTATTGCTAGCGGCTCAGCCGGCAATG | 103 | | 7 |
| | | GCGGAAGTTCAGCTGCTGGAATCTGGTGG | | | |
| | | CGGTCTGGTTCAG | | | |
| | | CCGGGTGGTTCTCTGCGTCTGTCCTGTGCA | | | |
| | | G | | | |
| VH2 | H1 | GGAAACCCATTCCAGGCCCTTGCCCGGCG | 98 | 5′-ph | 8 |
| | | CCTGACGAACCCAAKDCATCSMGKMGBYG | | | |
| | | CTGAAGGTAAAACC | | | |
| | | AGAGGCTGCACAGGACAGACGCAGAG | | | |
| VH3 | H2 | CAAGGGCCTGGAGTGGGTTTCCDHCATTA | 135 | 5′-ph | 9 |
| | | RHNMTRRTRGCRRCWMCAHATWTTATGC | | | |
| | | GGACTCTGTGAAAGG | | | |
| | | CCGTTTCACCATCTCTCGTGACAACTCCAA | | | |
| | | AAACACCCTGTACCTGCAGATGAACTCCCT | | | |
| | | GCG | | | |
| VH4a | H3 | CGACCTTGAAGCTTGCAGAAGAAACGGTC | 140 | | 10 |
| | (12) | AGGGTGGTACCCTGGCCCCAATAATCGAA | | | |
| | | SNNSNNSNNSNNSNN | | | |
| | | SNNSNNSNNSNNTYTCGCGCAGTAGTAAAC | | | |
| | | CGCGGTGTCTTCCGCGCGCAGGGAGTTCAT | | | |
| | | CTGCAGG | | | |
| VH4b | H3 | CGACCTTGAAGCTTGCAGAAGAAACGGTC | 137 | | 11 |
| | (11) | AGGGTGGTACCCTGGCCCCAATAATCGAA | | | |
| | | SNNSNNSNNSNNSNN | | | |
| | | SNNSNNSNNTYTCGCGCAGTAGTAAACCGC | | | |
| | | GGTGTCTTCCGCGCGCA | | | |
| | | GGGAGTTCATCTGCAGG | | | |
| VH4c | H3 | CGACCTTGAAGCTTGCAGAAGAAACGGTC | 134 | | 12 |
| | (10) | AGGGTGGTACCCTGGCCCCAATAATCGAA | | | |
| | | SNNSNNSNNSNNSNN | | | |
| | | SNNSNNTYTCGCGCAGTAGTAAACCGCGGT | | | |
| | | GTCTTCCGCGCGCAGGGAGTTCATCTGCAG | | | |
| | | G | | | |
| VH4d | H3 | CGACCTTGAAGCTTGCAGAAGAAACGGTC | 131 | | 13 |
| | (9) | AGGGTGGTACCCTGGCCCCAATAATCGAA | | | |
| | | SNNSNNSNNSNNSNN | | | |
| | | SNNTYTCGCGCAGTAGTAAACCGCGGTGTC | | | |
| | | TTCCGCGCGCAGGGAGTTCATCTGCAGG | | | |

### Example 3

### Gene Assembly of Antibody Variable Domains (VH and Vκ)

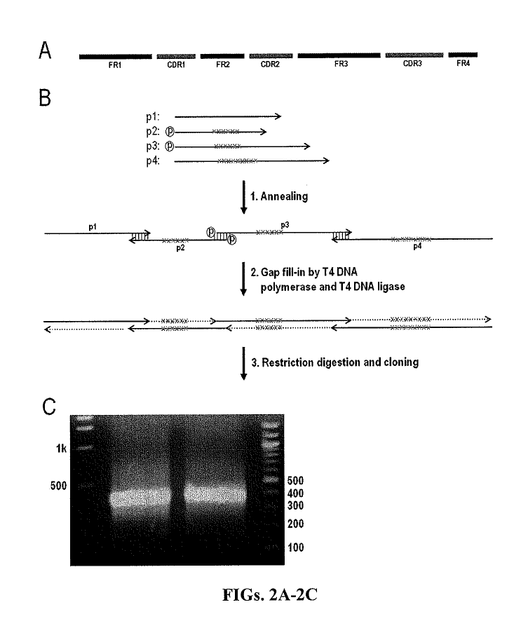

As demonstrated in FIGS. 2A-2C, there were two steps for V gene assembly, annealing and filling-in. The annealing reaction was typically carried out at the scale of 100 pmol in a volume of 100 μL. For CDRs encoded by multiple primers, DNA were used at equal molar (i.e. 25 pmol of VH4a/b/c/d, and 50 pmol of Vκ2a/b). The primers were mixed in 50 mM NaCl, 10 mM Tris-HCl (or alternatively in 1×NEBuffer 2). DNA annealing was preformed in thermocycler as the program was set as: denature of DNA at 95° C. for 5 min, then 70 cycles of 1 min incubation, at the temperature decreasing 1° C. for each cycle (94° C. to 25° C.), and finally kept at 4° C.

After annealing, the DNA samples were treated with T4 DNA polymerase and T4 DNA ligase simultaneously to fill-in the gaps on the double-stranded DNA. T4 DNA polymerase, instead of other polymerase (e.g. Klenow, Taq), was chosen, because it does not displace the primer on the growing strand. T4 DNA ligase was added to reaction mixture, to seal the nick gaps remaining after DNA polymerization. Comparing to common protocols using T4 DNA polymerase, this gap-filling reaction was optimized by: (1) Increasing dNTP from 200 μM to 500 μM to repress any exonuclease activity of T4 DNA polymerase. (2) Incubating at higher temperature for longer time (37° C. for 60 min instead of 12° C. for 20 min as suggested by the manufacturer) to drive the reaction to completion.

Specifically, reaction mixtures consisted of 100 pmol of annealed DNA resulting from the previous step, 500 μM dNTP, 1×T4 ligase buffer (containing 1 mM ATP and 10 mM dithiothreitol), 15 U of T4 DNA polymerase, 2000 U of T4 DNA ligase, and ddH₂O to total 200 μL and included the following steps: 1) 4° C. for 30 seconds, 2) 37° C. for 60 min, followed by 3) heat inactivation at 75° C. for 20 min. Subsequently the reaction mixture was held at 4° C. The assembled VH/Vκ genes were then purified using Zymo DNA Clean Kits (or other equivalent reagents). In this step, multiple silicon columns had to be used to provide sufficient absorbance capacity. Typically, the recovery rate of this step is 70-75%, with yield of about 15-18 μg VH/Vκ genes. The assembled VH/Vκ fragments were analyzed by electrophoresis and a single band with appropriate size can be clear seen (as the assembled VH shown in FIG. 2B).

### Example 4

### Construction of Vectors for In-Frame Selection of Variable Domain Libraries

Because of the library design and the scheme used for diversification, some of the genes are expected to contain stop codons. Sequencing of randomly picked colonies revealed that, ˜60% (12/19) of the clones carried full-length VH genes. Out of these 7 mutations, 3 were found to have stop codons at CDR3, 3 had single nucleotide deletions, and 1 had a 2 nucleotide deletions located in different primers. The mutations with stop codon were introduced by the NNS degeneracy within CDR-H3. Nucleotide deletions were probably caused by chemical synthesis errors.

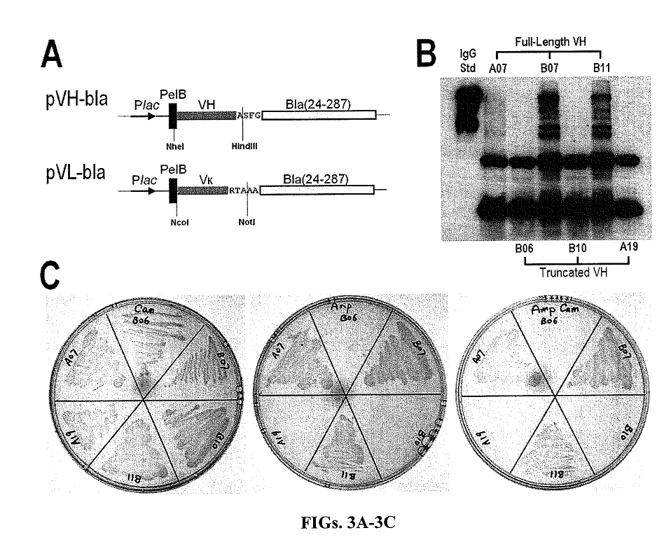

To reduce or eliminate frame-shifts and stop codons, the V gene libraries were subjected to in-frame selection by first constructing C-terminal fusions to β-lactamase followed by selection of transformants that display resistance to ampicillin. Ampicillin resistance can arise only from fusions encode a complete variable domain ORF fused to β-lactamase This methodology is well established in the art (Seehaus 1992; Lutz 2002; Rothe 2008). Briefly, the VH/Vκ selection vectors, pVH-bla and pVL-bla, were designed in the similar fashion, as shown in FIG. 3A. These two selection vectors were constructed using standard molecular cloning methods. Briefly, the 3748 bp fragment (NdeI/HindIII ended) of pMoPac1 and the 427 bp fragment (NdeI/HindIII ended) of pMAZ-A07 were ligated to give pVH. The bla genes, encoding β-lactamase, were amplified by polymerase chain reaction (PCR) with the primers xg109 and xg110. The PCR product was then double digested with HindIII and BamHI, and inserted into the same sites on pVH, and cultured on Cam⁺/Amp⁺ duplicate plate, to obtain the selection vector pVH-bla. For pVL-bla, the 3921 bp fragment (NdeI ended) of pMoPac1 was self-ligated to give pMoPac100. The NcoI site on pMoPac100 was removed by Quick Change site directed mutagenesis using primers xg115 and xg116, and resulted in pMoPac99. The 3637 bp fragment (KpnI/NotI ended) of pMoPac99 was ligated with the 608 bp fragment (KpnI/NotI ended) of pMAZ-A07 to give pVL. The bla gene was PCR amplified with primers xg110 and xg111. The PCR product was digested with NotI/BamHI, inserted into the same sites on pVL, and following ligation, transformants were cultured on selective Cam⁺/Amp⁺ plate. Table 4 lists all the primers used for cloning and sequencing.

TABLE 4
Polynucleotides used for cloning pVH-bla and
pVL-bla, and sequencing VH/Vκ genes.

| Name | Sequences | Length | SEQ ID NO: |
|---|---|---|---|
| xg109 | GCATAAGCTTCGGCcacccagaaacgctggtgaaag | 36 | 14 |
| xg110 | CGCAGTCTggatccgtttaagggcaccaataactgc | 36 | 15 |
| xg112 | TTGTGAGCGGATAACAATTTC | 21 | 16 |
| xg115 | Cttcgcccccgttttcacaatgggcaaatattatac | 36 | 17 |
| xg116 | gtataatatttgcccattgtgaaaacgggggcgaag | 36 | 18 |
| xg124 | CCAATCGGGTAACTCCCAGG | 20 | 19 |

Prior to introducing VH/Vκ gene libraries, the selection vector pVH-bla was tested using 6 known VH gene sequences. VH genes A07, B07 and B11 are full-length, B06 has stop codon in CDR3, and A19 and B10 have nucleotide deletions and reading frame shifts. These 6 VH genes are inserted in a vector expressing full length IgG format and the resulting construct was expressed in E. coli. As expected only those IgG genes that contained VH genes without stop codons or deletions gave rise to the expression of full length IgG determined by Western blotting (FIG. 3B). These 6 VH genes were sub-cloned into pVH-bla vector and cultured on agar plates supplemented with (1) 50 μg/ml ampicillin (Amp+); (2) 30 μg/ml chloramphenicol (Cam⁺); or (3) 50 μg/ml ampicillin and 30 μg/ml chloramphenicol (Amp⁺/Cam⁺). As shown in FIG. 3C, all three strains carrying full-length VH genes can grow on Amp+ or Amp⁺/Cam⁺ plates, but none of the clones carrying truncated VH genes can survive on plates containing 50 μg/ml ampicillin. Similar phenomena were observed for Vκ selection vector pVL-bla as well. These results suggest that pVH-bla/pVL-bla could be efficiently used to select for full-length and in-frame antibody variable domains.

15 μg assembled VH/Vκ genes were restriction digested at 37° C. overnight (NheI and HimdIII for VH, and NcoI and NotI for Vκ), then the DNA was gel purified and recovered with Qiagen (or Zymo) gel extraction kits. The eluted DNA samples were desalted and concentrated with membrane centrifugal filters (100,000 MWCO, Millipore), by dilution with ddH₂O and centrifugation at 2000×g for 5-10 minutes (repeated three times). The yields of cohesive-ended VH/Vκ were typically around 3-5 μg per reaction. 20 μg selection vector pVH-bla/pVL-bla was subjected to restriction digestion, gel purification, DNA extraction, and membrane desalting as above, generating a ˜4.6 Kbp fragment at concentration of 50-150 ng/μl (with recovery rate of ˜35%). To minimize colonies arising from self-ligation, vectors carry truncated VH/Vκ genes were used for cloning VH/Vκ libraries, since theses clones cannot grow on Amp+ plates even if self-ligation were to take place. For ligation reactions, 1 pmol of vector fragment (˜3 μg) and 2 pmol of assembled VH/Vκ genes (480 ng/460 ng) were mixed with 10 μl T4 DNA ligase in 200 μl reaction volume. Reaction took place at room temperature for 4 hours, then desalted by nitrocellulose (0.025 μM, Millipore) for 2 hours or by Zymo DNA clean kits (recovery usually greater than 75%) before electroporation.

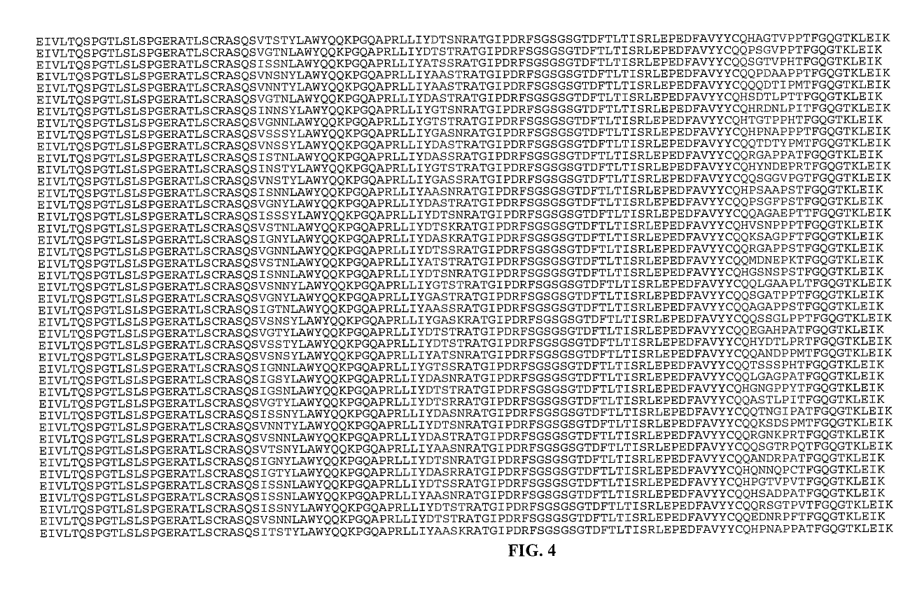

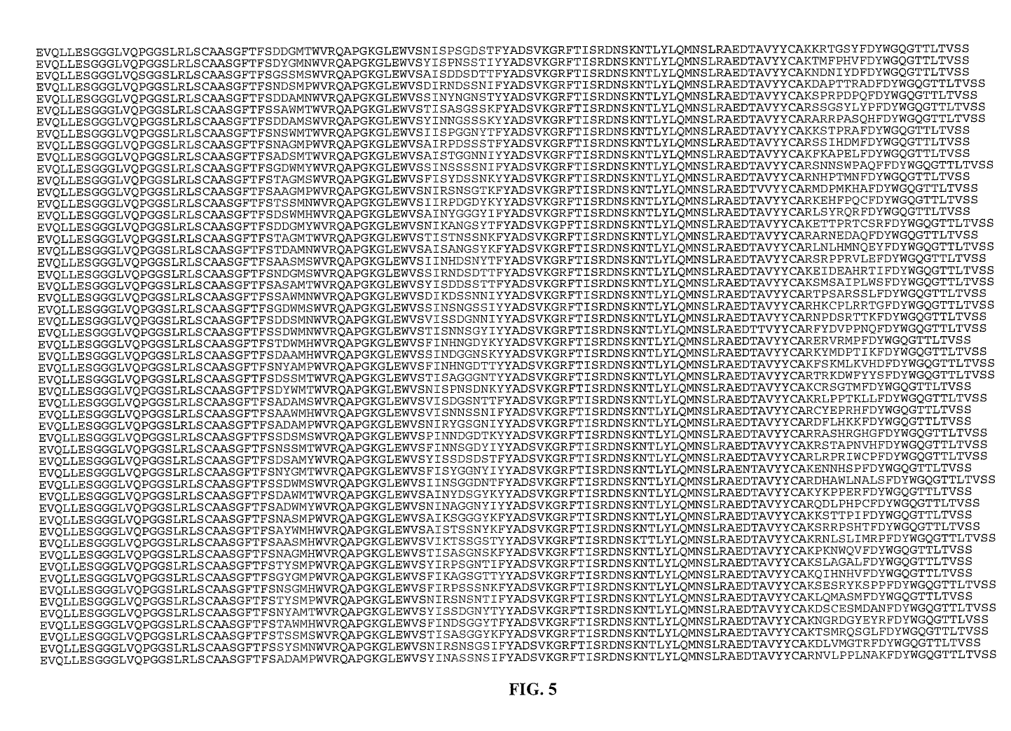

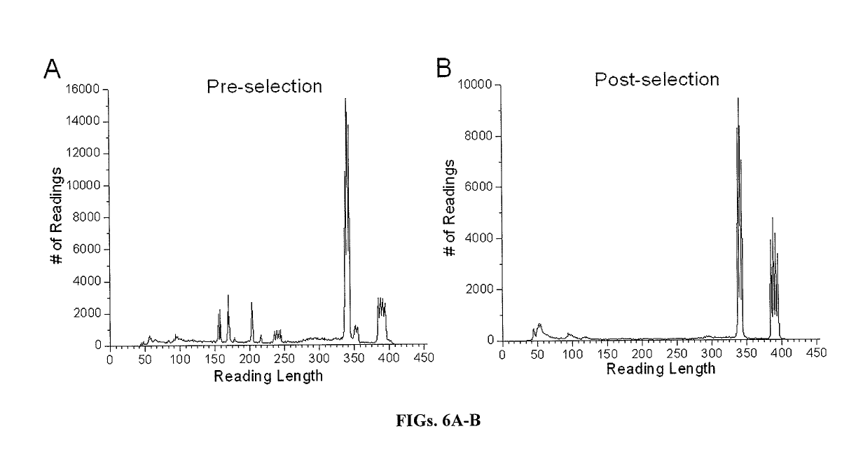

Electrocompetent cells were prepared as described previously (Mazor 2008). Electrocompetent cells with a transformation capacities of at least 5×10⁸ with 100 fmol (˜300 ng) plasmid DNA and 100 μl cells (approximally equivalent to 3 OD cells) were used. 1 ml electrocompetent cells and 3 μg ligated DNA were used to construct libraries with 10⁸-10⁹ transformants. Electroporation was performed using a Bio-Rad gene pulser using 6-8 electroporation cuvettes (2 mm gap) with constant voltage set to 2.5 kV. 3 ml of SOB media was added to each cuvette, and resuspended cells from all cuvettes were pooled. After culturing at 37° C. for 1 hour, the cells were spread to 6-8 square plates (600 cm² each) having 2×YT agar media supplemented with 0.5 mM IPTG, and 50 μg/ml ampicillin. These concentrations were optimized for efficient selection and large number of transformants. Plates were then incubated 12-16 hours at 30° C. The library size was estimated from serial dilutions, and the results indicate that there were 3.3×10⁸ transformants for VH library, and 1.7×10⁹ for Vκ library. Cell were collected and resuspended in LB supplemented with 30 μg/ml chloramphenicol and 25% glycerol. 100 clones of VH/Vκ libraries were randomly picked and cultured in LB supplemented with Cam⁺ and plasmid DNA was sequenced. Sequencing results demonstrated that 100% of the VH clones (54/54), and ˜92% of picked Vκ clones (43/46) are full-length with correct sequences. These full-length variable domain genes sequences are listed in FIG. 4 for VH and FIG. 5 for Vκ. These 58 sequencing results also suggest that amino acid coverage at all positions of CDRs are well matching with designed diversity.

### Example 5

### High-Throughput Sequencing

100 OD (>20 coverage) of E. coli carrying selected VH/Vκ gene libraries, were inoculated into 500 ml LB supplemented with 30 μg/ml chloramphenicol and 0.6% glucose, and cultured at 30° C. for 6 hours. Plasmids were extracted from harvested cells using Maxiprep Kits (Qiagen), restriction digested (NheI and HindIII for VH, and NcoI and NotI for Vκ), gel purified and concentrated (to >100 ng/μl). 4 μg of VH/Vκ DNA (denoted as post-selection), and purified 2 μg of assembled VH/Vκ (denoted as pre-selection), were used for high-throughput sequencing (Roche 454, SeqWright). All data analysis was done using custom made Perl language at Unix environment. Out of the raw data, sequences were grouped into VH-like and Vκ-like fragment pools by searching constant sequences located on FRs. Several motifs were used to minimize the effects of sequencing errors. Sequences adjacent to CDRs were then recognized to identify all of the 6 CDRs of both VH and Vκ. The entire programming chart flow for this data mining process is summarized in S1, and statistic analysis of thus identified CDRs are shown in Table 5.

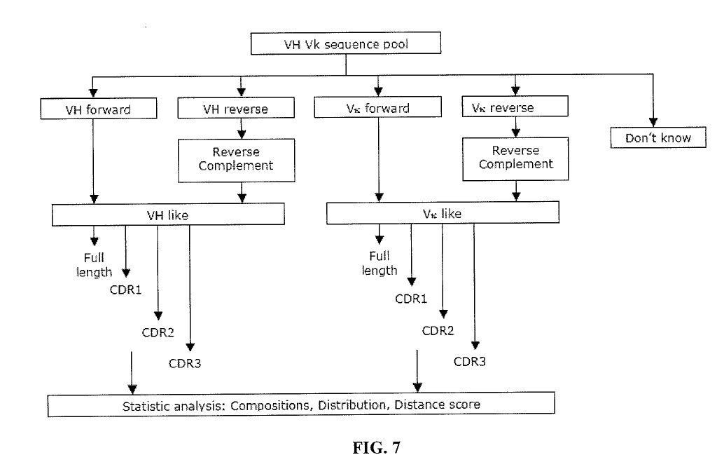

HTS (High throughput sequencing) “454’ DNA sequencing was used to characterize the sequence diversity of the synthetic antibody libraries described in Examples 1-4. Two samples were submitted for sequencing and the data were analyzed by bioinformatics: (1) assembled VH/Vκ genes by annealing and polymerization (denoted as pre-selection), and (2) fragments digested from pVH-bla or pVκ-bla selection vectors (denoted as post-selection). Raw data consisted of 210,000 and 96,653 sequences for pre-selection and post-selection samples respectively. Reading length distributions (FIG. 6) clearly show two clusters at ˜340 bp and ˜390 bp, corresponding to designed length of Vκ and VH. Out of these raw data, sequences were grouped into VH-like and Vκ-like fragment pools, and the 6 CDRs of both VH and Vκ were identified (FIG. 7 for the entire programming chart flow of the data mining process). The statistic results of thus identified sequences (Table 5) show there are average ˜48,000 readings for each CDRs, with evenly distribution for variable length (e.g. 25.0%, 29.3%, 25.1%, 20.7% for CDR-H3 with 6-9 NNS in the post-selection sample).

TABLE 5
Statistic results of identified CDRs.

| | Vk pre- | Vk post- | | VH pre- | VH-post- |
|---|---|---|---|---|---|
| | selection | selection | | selection | selection |
| Total | 112,829 | 53,517 | Total | 54,902 | 36,090 |
| CDR-L1a | 44,518 | 23,925 | CDR-H1 | 43,034 | 27,155 |
| (11aa) | | | | | |
| CDR-L1b | 50,878 | 18,889 | CDR-H2 | 36,609 | 26,439 |
| (12aa) | | | | | |
| CDR-L2 | 96,120 | 43,340 | CDR-H3a | 8,069 | 6,072 |
| | | | (9aa) | | |
| CDR-L3 | 80,537 | 38,356 | CDR-H3b | 8,122 | 7,122 |
| | | | (10aa) | | |
| Full length | 49,275 | 28,371 | CDR-H3c | 8,517 | 6,098 |
| | | | (11aa) | | |
| | | | CDR-H3d | 7,535 | 5,024 |
| | | | (12aa) | | |
| | | | Full length | 5,553 | 7,221 |

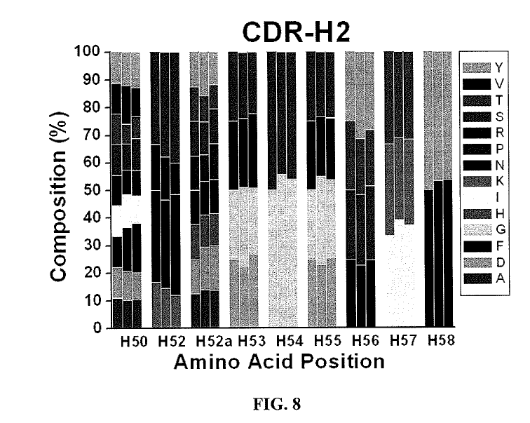

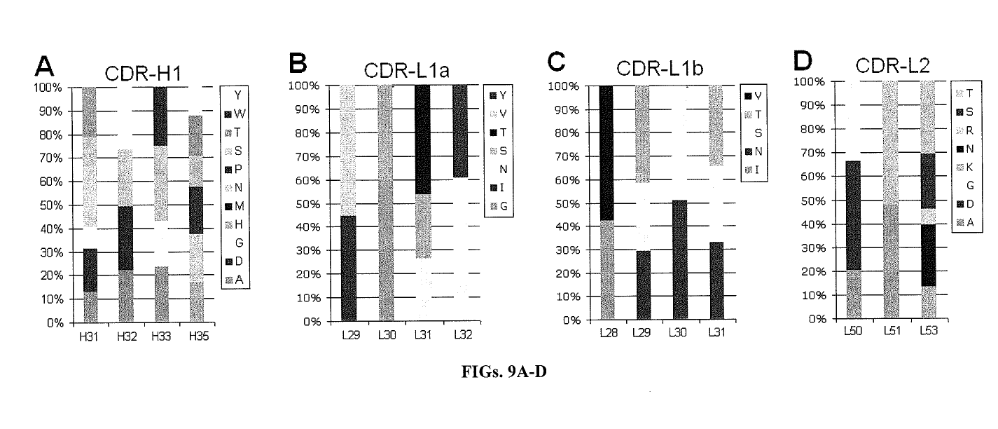

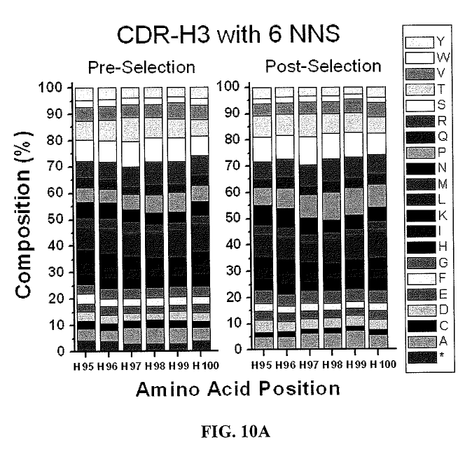

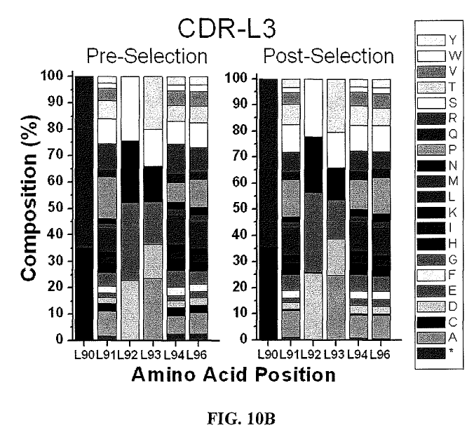

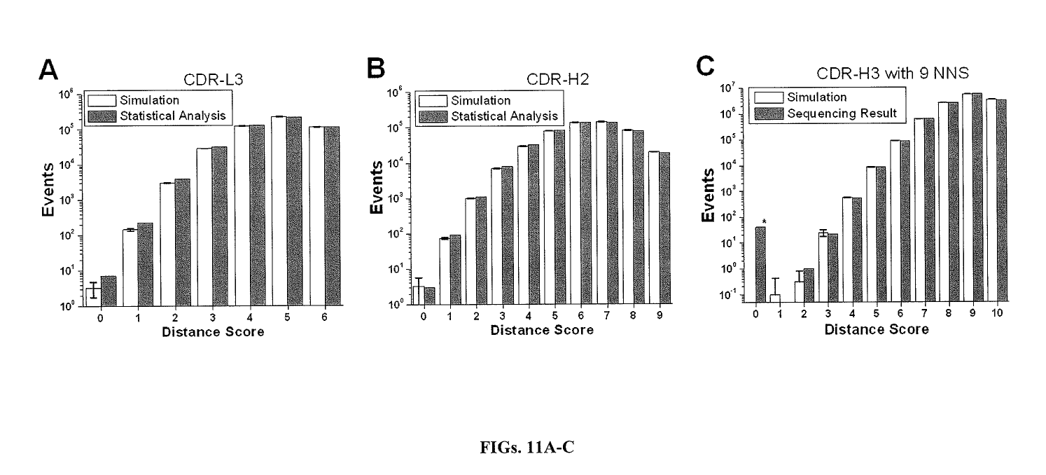

Diversity coverage was investigated firstly by analyzing amino acid composition at each individual residual position of CDRs. Results indicate that there are no significant deviations among design, pre- and post-selection samples for CDR-L1, L2, H1, H2 (FIGS. 8-9). For CDR-L3 and H3, all 20 amino acids were found for the positions encoded by degenerate NNS codons (FIGS. 10A-B). Thus the amino acid compositions in all 6 CDRs are in excellent agreement with the theoretical distribution. Moreover, statistical analysis of the sequence data validates the depletion of truncated sequences. For example in CDR-H3 with a length of 6 aa encoded by an NNS scheme is FIG. 10A, stop codon content at each single position is ˜3.5% on average before selection (consistent with theoretical possibility, 1/32, for NNS degenerate codon), while this number significantly drops to ˜0.1% after full-length selection. The percentages of sequences with a stop codon at any position were analyzed, for CDR-H3 having a length of 6-9 randomized residues, and the results are shown in Table 6. Before selection, approximate 18-28% CDR-H3 sequences contain a stop codon which well agrees with the estimated theoreticaldistribution (17-25%), calculated based on the equation p(n)=1−(31/32)ⁿ for (NNS)ₙ. After selection, the number of stop codons drops to ˜0.6% on average for (NNS)₆₋₉. Similar results are also found for CDR-L3 (FIG. 10B and Table 6). Above statistical analysis directly proves that the full-length selection depletes CDR3 sequences containing stop codon in a very efficient manner.

TABLE 6
Stop codon content in pre- and post-selection libraries and comparison with
theoretical possibility.

| | | Pre-selection | | | Post-selection | | |
|---|---|---|---|---|---|---|---|
| | Theoretically* | seq with | | | seq with | | |
| | % with stop | stop | total | | stop | total | |
| CDRs | codon | codon | sequences | % | codon | sequences | % |
| VH-6NNS | 17.3% | 1526 | 8069 | 18.9% | 35 | 6072 | 0.58% |
| VH-7NNS | 19.9% | 1469 | 8122 | 18.0% | 32 | 7122 | 0.45% |
| VH-8NNS | 22.4% | 1719 | 8517 | 20.2% | 42 | 6098 | 0.69% |
| VH-9NNS | 24.9% | 2074 | 7535 | 27.5% | 39 | 5024 | 0.78% |
| Vκ-3NNS | 9.1% | 5355 | 80537 | 6.65% | 803 | 38356 | 2.09% |

Note:
*The theoretical possibility to have stop codons in (NNS)ₙ is calculated based on equation, p(n) = 1 − (31/32)ⁿ.

It has been demonstrated that the most common problem with chemically synthesized polynucleotide synthesis is the existence of deletions (Hecker 1998). Further analysis was preformed to validate the removal of frame-shifted sequences following β-lactamase based selection. As an example, CDR-H2 was analyzed, which is one of the longest CDRs in design (10 aa). The numbers of full-length CDR-H2 (30 bases), or those with deletions (29, 28 bases) were calculated for both pre-selection and post-selection samples. Results indicate that 6.3% of CDR-H2 sequences are frame-shifted in pre-selection sample, and only 0.9% of that in post-selection sample; the latter number is within the expected error range generated by 454 sequencing (Huse 2007). This suggests that selection efficiently removes sequences with frame shifts, in addition to stop codons. Overall, the percentage of full-length VH/Vκ genes in post-selection sample are significant higher than that of pre-selection (Table 5).

The selection might also eliminate clones that are toxic to expression hosts. It is found that among 3 NNS positions in CDR-L3, content of cysteine decrease from 2.93±0.17% of pre-selection, to 0.56±0.05% of post-selection (FIG. 10B). For CDR-H3, the decrease of Cys content is also found as well (from 2.65±0.02% to 1.80±0.12%), but not as significant as Vκ. These results are consistent with previous studies that Cys is rarely presented in antibody V genes (Ewert 2003; Collis 2003; Silacci 2005), probably due to the disruption of disulfide bond forming. No significant changes were found for any other amino acids in CDR-L3 and H3.

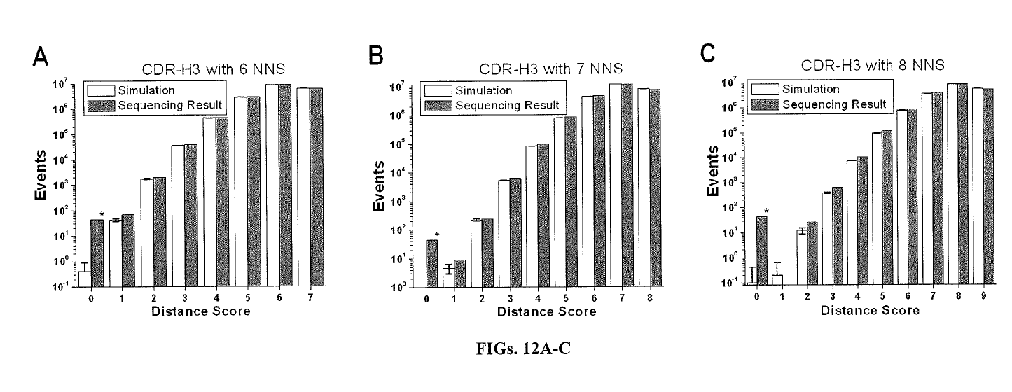

In addition to amino acid compositions at each single residue positions, statistical analysis was also preformed to characterize the combinatorial distribution for entire CDRs by studying their distance scores profiles. The distance between two chosen CDR sequences is calculated as compared with each amino acid position of the two CDR: if two sequences have the same the residue at position i, then dᵢ=0; otherwise dᵢ=1. The distance score between two CDR is the sum, D=Σdᵢ (e.g. for (NNS)₅, D=0 indicating exactly same pentapeptides; and D=5 indicating all 5 positions have different amino acids). Then the distance scores profiles of each CDR populations were generated by plotting the numbers of events with each possible distance. Statistical results were compared with average of 10 simulations, in which CDR sequences were randomly generated given the codon distribution in the library design (but without stop codons) and the distance score was calculated. The distance score profiles of CDR-L3, H2, and H3 with 9 NNS are displayed in FIGS. 11A-C (CDR-H3 with 6-8 NNS shown in FIG. 12), and reveal that the distance profiles in the experimental data are essentially identical to the simulations.

40 identical CDR-H3 sequences in the sublibrary with 9 randomized positions were found appearing twice out of 5024 samples (FIG. 11C). Further characterization of these duplicates indicates that: 1), the entire readings of these 40 pairs of sequences are exactly the same including CDR1-2; 2), Duplicated sequences found in pre-selection sample are different from the ones fund in post-selection sample; 3), the event numbers for distance score=1 in CDR-3H and 3L, are well matched with the simulation results (FIG. 11C, FIG. 12). These observations suggest these duplicates were probably generated by sequencing process, and therefore do not reflect a compromised diversity in the constructed libraries. The phenomenon of repeated reads is well known for 454 sequencer, as estimated that 11-35% of sequences in a typical metagenome are artificial replicates (Gomez-Alvarez 2009). It has been suggested that replicate reads from a single template may occur, either during emulsion PCR when amplified DNA attaches to empty beads or one water-in-oil droplet carries more than one beads, or during data collection when the optical signal enter the space of an adjacent empty well (Diehl 2006; Briggs 2007). For this study, duplicated sequences were found not in adjacent wells on the sequencing plate, and so we expect that the replicates are generated during emulsion PCR.

The error rate of the 454 sequencer (˜10⁻³) is roughly 4 magnitudes higher than the fidelity of T4 DNA polymerase (Kunkel 1984; Huse 2007). Thus, it's believed that HTS (High throughput sequencing) is suitable for study the diversity coverage etc. but unable for counting percentage of full-length VH/Vκ genes out of data pools. The most common sequence errors of chemical synthesis are deletion mutations, which are most likely to result from incomplete de-protection process (Hecker 1998). The selection by β-lactamase fusion is efficient for removal of sequences with frame-shift or containing stop codon. To validate the quality of obtained libraries (i.e. high percentage of V genes are full-length), totally 100 clones were randomly picked from VH/Vκ libraries, and the plasmids were minipreped and sequenced conventionally. Results demonstrated that 100% of picked VH genes (54/54), and ˜93% of picked Vκ genes (43/46) are full-length with correct FRs and expected CDR sequences. These three mutations of Vκ are single deletions, thus giving the totally mutation rates at constant region ˜10⁻⁶ (3 out of 100 Variable genes having ˜340-390 bp in length). Therefore, the functional size of obtained VH library was close to 3.7±0.3×10⁸ (the number of transformants of VH library), and the theoretical diversity of Vκ, 6.9×10⁸, was fully covered >2 folds (1.7±0.2×10⁸ transformants).

### Example 6

### Construction of Library in the IgG Formats

The selected variable domain genes were sub-cloned to IgG format for selection for specific antibodies. There were two steps for sub-cloning: (1) Sub-clone selected Vκ into IgG expression vector pMAZ to obtain pMAZ-Vκ. The library size=1.9×10⁹. (2) Sub-clone selected VH into pMAZ-Vκ, to obtain pMAZ-Vκ/VH. The library size=5×10⁹. Growth curve in 96-well plates were determined. Optimized condition for expression of IgG library were achieved.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
U.S. Pat. No. 4,356,270
U.S. Pat. No. 4,683,202
U.S. Pat. No. 5,302,523
U.S. Pat. No. 5,322,783
U.S. Pat. No. 5,348,867
U.S. Pat. No. 5,384,253
U.S. Pat. No. 5,464,765
U.S. Pat. No. 5,538,877
U.S. Pat. No. 5,538,880
U.S. Pat. No. 5,550,318
U.S. Pat. No. 5,563,055
U.S. Pat. No. 5,580,859
U.S. Pat. No. 5,589,466
U.S. Pat. No. 5,610,042
U.S. Pat. No. 5,656,610
U.S. Pat. No. 5,702,932
U.S. Pat. No. 5,736,524
U.S. Pat. No. 5,780,448
U.S. Pat. No. 5,789,215
U.S. Pat. No. 5,866,344
U.S. Pat. No. 5,928,906
U.S. Pat. No. 5,945,100
U.S. Pat. No. 5,981,274
U.S. Pat. No. 5,994,624
U.S. Pat. No. 7,094,571
U.S. Patent Appln. 60/915,183
U.S. Patent Appln. 60/982,652
U.S. Patent Publn. 2003/0036092
U.S. Patent Publn. 2004/0058403
U.S. Patent Publn. 2004/0072740
U.S. Patent Publn. 2005/0260736
U.S. Patent Publn. 2006/0029947
U.S. Patent Publn. 2007/0099267
U.S. Patent Publn. 2007/0258954
Ausubel et al., Current Protocols in Molecular Biology, Greene Publishing Associates and Wiley Interscience, N.Y., 1994.
Briggs et al. Proc. Natl. Acad. Sci. USA, 104:14616-14621, 2007.
Brown et al., Meth. Enzymol., 68:109-151, 1979.
Carbonelli et al., FEMS Microbiol. Lett., 177(1):75-82, 1999.
Chames et al., Proc. Natl. Acad. Sci. USA, 97(14):7969-7974, 2000.
Chen and Okayama, Mol. Cell Biol., 7(8):2745-2752, 1987.
Cocea, Biotechniques, 23(5):814-816, 1997.
Collis et al., J. Mol. Biol., 325:337-354, 2003.
Desai et al., Virology, 247(1):115-124, 1998.
Diehl et al., Nat. Methods, 3, 551-559, 2006.
Ewert et al., J. Mol. Biol., 325:531-553, 2003.
Fechheimer et al., Proc Natl. Acad. Sci. USA, 84:8463-8467, 1987.
Fellouse et al., J. Mol. Biol., 373(4):924-940, 2007.
Fellouse et al., Proc. Natl. Acad. Sci. USA, 101(34):12467-12472, 2004.
Fraley et al., Proc. Natl. Acad. Sci. USA, 76:3348-3352, 1979.
Gomez-Alvarez et al., ISME Journal, July 9. [Epub ahead of print]. 2009
Gopal, Mol. Cell. Biol., 5:1188-1190, 1985.
Graham and Van Der Eb, Virology, 52:456-467, 1973.
Griffiths and Duncan, Curr. Opin. Biotechnol., 9(1):102-108, 1998.
Harland and Weintraub, J. Cell Biol., 101(3):1094-1099, 1985.
Hecker and Rill, Biotechniques, 24, 256-260, 1998.
Hoogenboom and Winter, J. Mol. Biol., 227(2):381-388, 1992.
Hoogenboom et al., Adv. Drug Deliv. Rev., 31(1-2):5-31, 1998.
Hoogenboom, Nat. Biotechnol., 23(9):1105-1116, 2005.
Huse et al., Genome Biol., 8: 9. 2007
Kabat et al., In: Sequences of Proteins of Immunological Interest, 5^{th} Ed., Public Health Service, Natl. Institutes of Health, Bethesda, Md., 1991.
Kaeppler et al., Plant Cell Reports, 9:415-418, 1990.
Kaneda et al., Science, 243:375-378, 1989.
Kato et al, J. Biol. Chem., 266:3361-3364, 1991.
Kjaer et al., Eur. J. Endocrinol., 139(2):238-243, 1998.
Knappik et al., J. Mol. Biol., 296:57-86, 2000.
Kohler and Milstein, Nature, 256:495-497, 1975.
Kunkel et al. J. Biol. Chem., 259, 1539-1545, 1984.
Levenson et al., Hum. Gene Ther., 9(8):1233-1236, 1998.
Lutz et al., Protein Eng., 15:1025-1030, 2002.
Maniatis, et al., Molecular Cloning, A Laboratory Manual, Cold Spring Harbor Press, Cold Spring Harbor, N.Y., 1988.
Martin, Proteins, Structure, Function and Genetics, 25:130-133, 1996.
Mazor et al., Nat. Protocols, 3:1766-1777, 2008.
Narang et al., Meth. Enzymol., 68:90-98, 1979.
Nicolau and Sene, Biochim. Biophys. Acta, 721:185-190, 1982.
Nicolau et al., Methods Enzymol., 149:157-176, 1987.
Orlandi et al., Proc. Natl. Acad. Sci. USA, 86(10):3833-3837, 1989.
Pavlou and Belsey, Eur. J. Pharm. Biopharm., 59(3):389-396, 2005.
PCT Appln. WO 94/09699
PCT Appln. WO 95/06128
Potrykus et al., Mol. Gen. Genet., 199(2):169-177, 1985.
Puigb et al., Nucleic Acids Res., 35:W126-W131, 2007.
Rippe, et al., Mol. Cell Biol., 10:689-695, 1990.
Rothe et al., J. Mol. Biol., 376(4):1182-200, 2008.
Sambrook and Russell, Molecular Cloning: A Laboratory Manual, 3rd Edition, Cold Spring Harbor Laboratory, N.Y., 1989.
Seehaus et al., Gene, 114(2):235-237, 1992.
Silacci et al., Proteomics, 5(9):2340-2350, 2005
Wong et al., Gene, 10:87-94, 1980.
Rothe et al., J. Mol. Biol., 376:1182-1200, 2008.

1. A method of preparing a library of vectors encoding different antibody sequences, comprising the steps of:
a) annealing a first population of polynucleotides with at least a second population of polynucleotides, said first population comprising nucleotide sequences encoding an immunoglobulin complementarity determining region (CDR), wherein said CDR is diversified at one or more amino acid positions, said at least a second population comprising nucleotide sequences complementary to the nucleotide sequences comprised in said first population;
b) preparing double-stranded polynucleotides comprising nucleotide sequences encoding an immunoglobulin variable domain that incorporates the diversified CDR from extending strands of the annealed polynucleotides; and
c) inserting the double-stranded polynucleotides into a vector to provide a library of vectors, with two or more members of said library comprising different antibody coding sequences,
wherein steps a), b) and c) are performed without the use of PCR amplification.

2. The method of claim 1, further comprising introducing the library of vectors into host cells.

3. The method of claim 2, further comprising culturing and separating the host cells into two or more individual clonal colonies.

4. A method of preparing a library of double-stranded polynucleotides, comprising the steps of:
a) providing a first population of polynucleotides, said first population comprising nucleotide sequences encoding an immunoglobulin complementarity determining region (CDR), wherein said CDR is diversified at one or more amino acid positions;
b) providing at least a second population of polynucleotides, said at least a second population comprising nucleotide sequences complementary to the nucleotide sequences comprised in said first population and capable of annealing to the first population of polynucleotides to form annealed polynucleotides that comprise nucleotide sequences encoding an immunoglobulin variable domain, wherein the immunoglobulin variable domain comprises the diversified CDR and an additional CDR;
c) annealing the polynucleotides of the first population and the polynucleotides of the at least a second population; and
d) extending strands of the annealed polynucleotides to prepare a library of double-stranded polynucleotides.

5. The method of claim 4, further comprising amplifying the double-stranded polynucleotides.

6. The method of claim 4, further comprising inserting the double-stranded polynucleotides into a vector to provide a library of vectors, with two or more members of said library comprising different antibody coding sequences.

7. The method of claim 6, further comprising introducing the library of vectors into host cells.

8. The method of claim 7, further comprising culturing and separating the host cells into two or more individual clonal colonies.

9. The method of claim 1, wherein the polynucleotides of the first or second population are about 75 to about 200 nucleotides in length.

10. The method of claim 9, wherein the polynucleotides of the first or second population are about 90 nucleotides in length.

11. The method of claim 9, wherein the polynucleotides of the first or second population are at least 180 nucleotides in length.

12. The method of claim 11, wherein the polynucleotides of the first or second population are at least 250 nucleotides in length.

13. The method of claim 1, wherein the polynucleotides of the first or second population are chemically synthesized.

14. The method of claim 1, wherein the at least a second population comprise two or three different populations.

15. The method of claim 1, wherein the diversified CDR comprise CDR3.

16. The method of claims 15, wherein the diversified CDR comprise CDR1 and CDR3.

17. The method of claims 16, wherein the diversified CDR comprise CDR1, CDR2, and CDR3.

18. The method of claim 1, further comprising filling in gaps on the double-stranded polynucleotides.

19. The method of claim 18, wherein filling the gaps comprises using a ligase.

20. The method of claim 1, wherein the immunoglobulin variable domain encoded by the double-stranded polynucleotides so prepared is a complete immunoglobulin variable domain.

21. The method of claim 1, wherein the vector is an expression vector.

22. The method of claim 21, wherein the expression vector comprise coding sequences for an antibody framework to generate an antibody library expressing diversified immunoglobulin variable domains.

23. The method of claim 21, wherein the expression vector is a microbial expression vector.

24. The method of claim 23, wherein the expression vector is an E. coli expression vector.

25. The method of claim 24, further comprising using E-clonal technology for screen of immunoglobulin variable domains.

26. A polynucleotide library prepared by the method of claim 4.

27. A diversified antibody library comprising amino acid sequences encoded by the polynucleotide library of claim 26.


SEQUENCE LISTING (117 sequences)

SEQ ID NO: 1 - protein, 8 aa, Artificial Sequence
  Synthetic peptide
ASFXTAAA

SEQ ID NO: 2 - DNA, 93 bp, Artificial Sequence
  Synthetic primer
ccagccggccatggcggaaatcgttctgacccagtctccgggtaccctgtctctgtctccgggtgaacgtgcgaccctgtcttgccgtgccag

SEQ ID NO: 3 - DNA, 90 bp, Artificial Sequence
  Synthetic primer
cgtagatcagcagacgcggcgcctgacccggtttctgctggtaccacgccagatwgbtgcyaaygctctggctggcacggcaagacaggg

SEQ ID NO: 4 - DNA, 93 bp, Artificial Sequence
  Synthetic primer
cgtagatcagcagacgcggcgcctgacccggtttctgctggtaccacgccagatagbtgytgbtaaygctctggctggcacggcaagacaggg

SEQ ID NO: 5 - DNA, 121 bp, Artificial Sequence
  Synthetic primer
gccgcgtctgctgatctacgvcrccagcavhcgtgcgaccggtatcccggaccgtttctctggttctggttctggtaccgacttcaccctgaccatctctcgtctggaaccggaagacttc

SEQ ID NO: 6 - DNA, 119 bp, Artificial Sequence
  Synthetic primer
gacagatggtgcggccgcggtacgtttgatttccagtttggtaccctgaccgaaggtsnncggsnngbygyysnnhtgctggcagtagtaaaccgcgaagtcttccggttccagacgag

SEQ ID NO: 7 - DNA, 103 bp, Artificial Sequence
  Synthetic primer
gcgttattgctagcggctcagccggcaatggcggaagttcagctgctggaatctggtggcggtctggttcagccgggtggttctctgcgtctgtcctgtgcag

SEQ ID NO: 8 - DNA, 98 bp, Artificial Sequence
  Synthetic primer
ggaaacccattccaggcccttgcccggcgcctgacgaacccaakdcatcsmgkmgbygctgaaggtaaaaccagaggctgcacaggacagacgcagag

SEQ ID NO: 9 - DNA, 135 bp, Artificial Sequence
  Synthetic primer
caagggcctggagtgggtttccdhcattarhnmtrrtrgcrrcwmcahatwttatgcggactctgtgaaaggccgtttcaccatctctcgtgacaactccaaaaacaccctgtacctgcagatgaactccctgcg

SEQ ID NO: 10 - DNA, 140 bp, Artificial Sequence
  Synthetic primer
cgaccttgaagcttgcagaagaaacggtcagggtggtaccctggccccaataatcgaasnnsnnsnnsnnsnnsnnsnnsnnsnntytcgcgcagtagtaaaccgcggtgtcttccgcgcgcagggagttcatctgcagg

SEQ ID NO: 11 - DNA, 137 bp, Artificial Sequence
  Synthetic primer
cgaccttgaagcttgcagaagaaacggtcagggtggtaccctggccccaataatcgaasnnsnnsnnsnnsnnsnnsnnsnntytcgcgcagtagtaaaccgcggtgtcttccgcgcgcagggagttcatctgcagg

SEQ ID NO: 12 - DNA, 134 bp, Artificial Sequence
  Synthetic primer
cgaccttgaagcttgcagaagaaacggtcagggtggtaccctggccccaataatcgaasnnsnnsnnsnnsnnsnnsnntytcgcgcagtagtaaaccgcggtgtcttccgcgcgcagggagttcatctgcagg

SEQ ID NO: 13 - DNA, 131 bp, Artificial Sequence
  Synthetic primer
cgaccttgaagcttgcagaagaaacggtcagggtggtaccctggccccaataatcgaasnnsnnsnnsnnsnnsnntytcgcgcagtagtaaaccgcggtgtcttccgcgcgcagggagttcatctgcagg

SEQ ID NO: 14 - DNA, 36 bp, Artificial Sequence
  Synthetic primer
gcataagcttcggccacccagaaacgctggtgaaag

SEQ ID NO: 15 - DNA, 36 bp, Artificial Sequence
  Synthetic primer
cgcagtctggatccgtttaagggcaccaataactgc

SEQ ID NO: 16 - DNA, 21 bp, Artificial Sequence
  Synthetic primer
ttgtgagcggataacaatttc

SEQ ID NO: 17 - DNA, 36 bp, Artificial Sequence
  Synthetic primer
cttcgcccccgttttcacaatgggcaaatattatac

SEQ ID NO: 18 - DNA, 36 bp, Artificial Sequence
  Synthetic primer
gtataatatttgcccattgtgaaaacgggggcgaag

SEQ ID NO: 19 - DNA, 20 bp, Artificial Sequence
  Synthetic primer
ccaatcgggtaactcccagg

SEQ ID NO: 20 - protein, 107 aa, Artificial Sequence
  Synthetic peptide
EIVLTQSPGTLSLSPGERATLSCRASQSXXXXLAWYQQKPGQAPRLLIYXXSXRATGIPDRFSGSGSGTDFTLTISRLEPEDFAVYYCQXXXXXPXTFGQGTKLEIK

SEQ ID NO: 21 - protein, 119 aa, Artificial Sequence
  Synthetic peptide
EVQLLESGGGLVQPGGSLRLSCAASGFTFSXXXMXWVRQAPGKGLEWVSXIXXXXXXXXYADSVKGRFTISRDNSKNTLYLQMNSLRAEDTAVYYCAXXXXXXXXFDYWGQGTTLTVSS

SEQ ID NO: 22 - protein, 108 aa, Artificial Sequence
  Synthetic peptide
EIVLTQSPGTLSLSPGERATLSCRASQSVTSTYLAWYQQKPGQAPRLLIYDTSNRATGIPDRFSGSGSGTDFTLTISRLEPEDFAVYYCQHAGTVPPTFGQGTKLEIK

SEQ ID NO: 23 - protein, 107 aa, Artificial Sequence
  Synthetic peptide
EIVLTQSPGTLSLSPGERATLSCRASQSVGTNLAWYQQKPGQAPRLLIYDTSTRATGIPDRFSGSGSGTDFTLTISRLEPEDFAVYYCQQPSGVPPTFGQGTKLEIK

SEQ ID NO: 24 - protein, 107 aa, Artificial Sequence
  Synthetic peptide
EIVLTQSPGTLSLSPGERATLSCRASQSISSNLAWYQQKPGQAPRLLIYATSSRATGIPDRFSGSGSGTDFTLTISRLEPEDFAVYYCQQSGTVPHTFGQGTKLEIK

SEQ ID NO: 25 - protein, 108 aa, Artificial Sequence
  Synthetic peptide
EIVLTQSPGTLSLSPGERATLSCRASQSVNSNYLAWYQQKPGQAPRLLIYAASTRATGIPDRFSGSGSGTDFTLTISRLEPEDFAVYYCQQPDAAPPTFGQGTKLEIK

SEQ ID NO: 26 - protein, 108 aa, Artificial Sequence
  Synthetic peptide
EIVLTQSPGTLSLSPGERATLSCRASQSVNNTYLAWYQQKPGQAPRLLIYAASTRATGIPDRFSGSGSGTDFTLTISRLEPEDFAVYYCQQQDTIPMTFGQGTKLEIK

SEQ ID NO: 27 - protein, 107 aa, Artificial Sequence
  Synthetic peptide
EIVLTQSPGTLSLSPGERATLSCRASQSVGTNLAWYQQKPGQAPRLLIYDASTRATGIPDRFSGSGSGTDFTLTISRLEPEDFAVYYCQHSDTLPTTFGQGTKLEIK

SEQ ID NO: 28 - protein, 108 aa, Artificial Sequence
  Synthetic peptide
EIVLTQSPGTLSLSPGERATLSCRASQSINNSYLAWYQQKPGQAPRLLIYGTSNRATGIPDRFSGSGSGTDFTLTISRLEPEDFAVYYCQHRDNLPITFGQGTKLEIK

SEQ ID NO: 29 - protein, 107 aa, Artificial Sequence
  Synthetic peptide
EIVLTQSPGTLSLSPGERATLSCRASQSVGNNLAWYQQKPGQAPRLLIYGTSTRATGIPDRFSGSGSGTDFTLTISRLEPEDFAVYYCQHTGTPPHTFGQGTKLEIK

SEQ ID NO: 30 - protein, 108 aa, Artificial Sequence
  Synthetic peptide
EIVLTQSPGTLSLSPGERATLSCRASQSVSSSYLAWYQQKPGQAPRLLIYGASNRATGIPDRFSGSGSGTDFTLTISRLEPEDFAVYYCQHPNAPPPTFGQGTKLEIK

SEQ ID NO: 31 - protein, 108 aa, Artificial Sequence
  Synthetic peptide
EIVLTQSPGTLSLSPGERATLSCRASQSVNSSYLAWYQQKPGQAPRLLIYDASTRATGIPDRFSGSGSGTDFTLTISRLEPEDFAVYYCQQTDTYPMTFGQGTKLEIK

SEQ ID NO: 32 - protein, 107 aa, Artificial Sequence
  Synthetic peptide
EIVLTQSPGTLSLSPGERATLSCRASQSISTNLAWYQQKPGQAPRLLIYDASSRATGIPDRFSGSGSGTDFTLTISRLEPEDFAVYYCQQRGAPPATFGQGTKLEIK

SEQ ID NO: 33 - protein, 108 aa, Artificial Sequence
  Synthetic peptide
EIVLTQSPGTLSLSPGERATLSCRASQSINSTYLAWYQQKPGQAPRLLIYGTSTRATGIPDRFSGSGSGTDFTLTISRLEPEDFAVYYCQHYNDEPRTFGQGTKLEIK

SEQ ID NO: 34 - protein, 108 aa, Artificial Sequence
  Synthetic peptide
EIVLTQSPGTLSLSPGERATLSCRASQSVNSTYLAWYQQKPGQAPRLLIYGASSRATGIPDRFSGSGSGTDFTLTISRLEPEDFAVYYCQQSGGVPGTFGQGTKLEIK

SEQ ID NO: 35 - protein, 107 aa, Artificial Sequence
  Synthetic peptide
EIVLTQSPGTLSLSPGERATLSCRASQSISNNLAWYQQKPGQAPRLLIYAASNRATGIPDRFSGSGSGTDFTLTISRLEPEDFAVYYCQHPSAAPSTFGQGTKLEIK

SEQ ID NO: 36 - protein, 107 aa, Artificial Sequence
  Synthetic peptide
EIVLTQSPGTLSLSPGERATLSCRASQSVGNYLAWYQQKPGQAPRLLIYDASTRATGIPDRFSGSGSGTDFTLTISRLEPEDFAVYYCQQPSGFPSTFGQGTKLEIK

SEQ ID NO: 37 - protein, 108 aa, Artificial Sequence
  Synthetic peptide
EIVLTQSPGTLSLSPGERATLSCRASQSISSSYLAWYQQKPGQAPRLLIYDTSNRATGIPDRFSGSGSGTDFTLTISRLEPEDFAVYYCQQAGAEPTTFGQGTKLEIK

SEQ ID NO: 38 - protein, 107 aa, Artificial Sequence
  Synthetic peptide
EIVLTQSPGTLSLSPGERATLSCRASQSVSTNLAWYQQKPGQAPRLLIYDTSKRATGIPDRFSGSGSGTDFTLTISRLEPEDFAVYYCQHVSNPPPTFGQGTKLEIK

SEQ ID NO: 39 - protein, 107 aa, Artificial Sequence
  Synthetic peptide
EIVLTQSPGTLSLSPGERATLSCRASQSIGNYLAWYQQKPGQAPRLLIYDASKRATGIPDRFSGSGSGTDFTLTISRLEPEDFAVYYCQQKSAGPFTFGQGTKLEIK

SEQ ID NO: 40 - protein, 107 aa, Artificial Sequence
  Synthetic peptide
EIVLTQSPGTLSLSPGERATLSCRASQSVGNNLAWYQQKPGQAPRLLIYDTSSRATGIPDRFSGSGSGTDFTLTISRLEPEDFAVYYCQQRGAPPSTFGQGTKLEIK

SEQ ID NO: 41 - protein, 107 aa, Artificial Sequence
  Synthetic peptide
EIVLTQSPGTLSLSPGERATLSCRASQSVSTNLAWYQQKPGQAPRLLIYATSTRATGIPDRFSGSGSGTDFTLTISRLEPEDFAVYYCQQMDNEPKTFGQGTKLEIK

SEQ ID NO: 42 - protein, 107 aa, Artificial Sequence
  Synthetic peptide
EIVLTQSPGTLSLSPGERATLSCRASQSISNNLAWYQQKPGQAPRLLIYDTSNRATGIPDRFSGSGSGTDFTLTISRLEPEDFAVYYCQHGSNSPSTFGQGTKLEIK

SEQ ID NO: 43 - protein, 108 aa, Artificial Sequence
  Synthetic peptide
EIVLTQSPGTLSLSPGERATLSCRASQSVSNNYLAWYQQKPGQAPRLLIYGTSTRATGIPDRFSGSGSGTDFTLTISRLEPEDFAVYYCQQLGAAPLTFGQGTKLEIK

SEQ ID NO: 44 - protein, 107 aa, Artificial Sequence
  Synthetic peptide
EIVLTQSPGTLSLSPGERATLSCRASQSVGNYLAWYQQKPGQAPRLLIYGASTRATGIPDRFSGSGSGTDFTLTISRLEPEDFAVYYCQQSGATPPTFGQGTKLEIK

SEQ ID NO: 45 - protein, 107 aa, Artificial Sequence
  Synthetic peptide
EIVLTQSPGTLSLSPGERATLSCRASQSIGTNLAWYQQKPGQAPRLLIYAASSRATGIPDRFSGSGSGTDFTLTISRLEPEDFAVYYCQQAGAPPSTFGQGTKLEIK

SEQ ID NO: 46 - protein, 108 aa, Artificial Sequence
  Synthetic peptide
EIVLTQSPGTLSLSPGERATLSCRASQSVSNSYLAWYQQKPGQAPRLLIYGASKRATGIPDRFSGSGSGTDFTLTISRLEPEDFAVYYCQQSSGLPPTFGQGTKLEIK

SEQ ID NO: 47 - protein, 107 aa, Artificial Sequence
  Synthetic peptide
EIVLTQSPGTLSLSPGERATLSCRASQSVGTYLAWYQQKPGQAPRLLIYDTSTRATGIPDRFSGSGSGTDFTLTISRLEPEDFAVYYCQQEGAHPATFGQGTKLEIK

SEQ ID NO: 48 - protein, 108 aa, Artificial Sequence
  Synthetic peptide
EIVLTQSPGTLSLSPGERATLSCRASQSVSSTYLAWYQQKPGQAPRLLIYDTSTRATGIPDRFSGSGSGTDFTLTISRLEPEDFAVYYCQHYDTLPRTFGQGTKLEIK

SEQ ID NO: 49 - protein, 108 aa, Artificial Sequence
  Synthetic peptide
EIVLTQSPGTLSLSPGERATLSCRASQSVSNSYLAWYQQKPGQAPRLLIYATSNRATGIPDRFSGSGSGTDFTLTISRLEPEDFAVYYCQQANDPPMTFGQGTKLEIK

SEQ ID NO: 50 - protein, 107 aa, Artificial Sequence
  Synthetic peptide
EIVLTQSPGTLSLSPGERATLSCRASQSIGNNLAWYQQKPGQAPRLLIYGTSSRATGIPDRFSGSGSGTDFTLTISRLEPEDFAVYYCQQTSSSPHTFGQGTKLEIK

SEQ ID NO: 51 - protein, 107 aa, Artificial Sequence
  Synthetic peptide
EIVLTQSPGTLSLSPGERATLSCRASQSIGSYLAWYQQKPGQAPRLLIYDASNRATGIPDRFSGSGSGTDFTLTISRLEPEDFAVYYCQQLGAGPATFGQGTKLEIK

SEQ ID NO: 52 - protein, 107 aa, Artificial Sequence
  Synthetic peptide
EIVLTQSPGTLSLSPGERATLSCRASQSIGSNLAWYQQKPGQAPRLLIYDTSTRATGIPDRFSGSGSGTDFTLTISRLEPEDFAVYYCQHGNGPPYTFGQGTKLEIK

SEQ ID NO: 53 - protein, 107 aa, Artificial Sequence
  Synthetic peptide
EIVLTQSPGTLSLSPGERATLSCRASQSVGTYLAWYQQKPGQAPRLLIYDTSRRATGIPDRFSGSGSGTDFTLTISRLEPEDFAVYYCQQASTLPITFGQGTKLEIK

SEQ ID NO: 54 - protein, 108 aa, Artificial Sequence
  Synthetic peptide
EIVLTQSPGTLSLSPGERATLSCRASQSISSNYLAWYQQKPGQAPRLLIYDASNRATGIPDRFSGSGSGTDFTLTISRLEPEDFAVYYCQQTNGIPATFGQGTKLEIK

SEQ ID NO: 55 - protein, 108 aa, Artificial Sequence
  Synthetic peptide
EIVLTQSPGTLSLSPGERATLSCRASQSVNNTYLAWYQQKPGQAPRLLIYDTSNRATGIPDRFSGSGSGTDFTLTISRLEPEDFAVYYCQQKSDSPMTFGQGTKLEIK

SEQ ID NO: 56 - protein, 107 aa, Artificial Sequence
  Synthetic peptide
EIVLTQSPGTLSLSPGERATLSCRASQSVSNNLAWYQQKPGQAPRLLIYDASTRATGIPDRFSGSGSGTDFTLTISRLEPEDFAVYYCQQRGNKPRTFGQGTKLEIK

SEQ ID NO: 57 - protein, 108 aa, Artificial Sequence
  Synthetic peptide
EIVLTQSPGTLSLSPGERATLSCRASQSVTSNYLAWYQQKPGQAPRLLIYAASNRATGIPDRFSGSGSGTDFTLTISRLEPEDFAVYYCQQSGTRPQTFGQGTKLEIK

SEQ ID NO: 58 - protein, 107 aa, Artificial Sequence
  Synthetic peptide
EIVLTQSPGTLSLSPGERATLSCRASQSIGNYLAWYQQKPGQAPRLLIYDTSNRATGIPDRFSGSGSGTDFTLTISRLEPEDFAVYYCQQANDRPATFGQGTKLEIK

SEQ ID NO: 59 - protein, 107 aa, Artificial Sequence
  Synthetic peptide
EIVLTQSPGTLSLSPGERATLSCRASQSIGTYLAWYQQKPGQAPRLLIYDASRRATGIPDRFSGSGSGTDFTLTISRLEPEDFAVYYCQHQNNQPCTFGQGTKLEIK

SEQ ID NO: 60 - protein, 107 aa, Artificial Sequence
  Synthetic peptide
EIVLTQSPGTLSLSPGERATLSCRASQSISSNLAWYQQKPGQAPRLLIYDTSSRATGIPDRFSGSGSGTDFTLTISRLEPEDFAVYYCQHPGTVPVTFGQGTKLEIK

SEQ ID NO: 61 - protein, 107 aa, Artificial Sequence
  Synthetic peptide
EIVLTQSPGTLSLSPGERATLSCRASQSISSNLAWYQQKPGQAPRLLIYAASNRATGIPDRFSGSGSGTDFTLTISRLEPEDFAVYYCQQHSADPATFGQGTKLEIK

SEQ ID NO: 62 - protein, 108 aa, Artificial Sequence
  Synthetic peptide
EIVLTQSPGTLSLSPGERATLSCRASQSISSNYLAWYQQKPGQAPRLLIYDTSTRATGIPDRFSGSGSGTDFTLTISRLEPEDFAVYYCQQRSGTPVTFGQGTKLEIK

SEQ ID NO: 63 - protein, 107 aa, Artificial Sequence
  Synthetic peptide
EIVLTQSPGTLSLSPGERATLSCRASQSVSNNLAWYQQKPGQAPRLLIYDTSTRATGIPDRFSGSGSGTDFTLTISRLEPEDFAVYYCQQEDNRPFTFGQGTKLEIK

SEQ ID NO: 64 - protein, 108 aa, Artificial Sequence
  Synthetic peptide
EIVLTQSPGTLSLSPGERATLSCRASQSITSTYLAWYQQKPGQAPRLLIYAASKRATGIPDRFSGSGSGTDFTLTISRLEPEDFAVYYCQHPNAPPATFGQGTKLEIK

SEQ ID NO: 65 - protein, 118 aa, Artificial Sequence
  Synthetic peptide
EVQLLESGGGLVQPGGSLRLSCAASGFTFSDDGMTWVRQAPGKGLEWVSNISPSGDSTFYADSVKGRFTISRDNSKNTLYLQMNSLRAEDTAVYYCAKKRTGSYFDYWGQGTTLTVSS

SEQ ID NO: 66 - protein, 118 aa, Artificial Sequence
  Synthetic peptide
EVQLLESGGGLVQPGGSLRLSCAASGFTFSDYGMNWVRQAPGKGLEWVSYISPNSSTIYYADSVKGRFTISRDNSKNTLYLQMNSLRAEDTAVYYCAKTMFPHVFDYWGQGTTLTVSS

SEQ ID NO: 67 - protein, 118 aa, Artificial Sequence
  Synthetic peptide
EVQLLESGGGLVQSGGSLRLSCAASGFTFSGSSMSWVRQAPGKGLEWVSAISDDSDTTFYADSVKGRFTISRDNSKNTLYLQMNSLRAEDTAVYYCAKNDNIYDFDYWGQGTTLTVSS

SEQ ID NO: 68 - protein, 120 aa, Artificial Sequence
  Synthetic peptide
EVQLLESGGGLVQPGGSLRLSCAASGFTFSNDSMPWVRQAPGKGLEWVSDIRNDSSNIFYADSVKGRFTISRDNSKNTLYLQMNSLRAEDTAVYYCAKDAPTTRADFDYWGQGTTLTVSS

SEQ ID NO: 69 - protein, 119 aa, Artificial Sequence
  Synthetic peptide
EVQLLESGGGLVQPGGSLRLSCAASGFTFSDDAMNWVRQAPGKGLEWVSSINYNGNSTYYADSVKGRFTISRDNSKNTLYLQMNSLRAEDTAVYYCAKSPRPDPQFDYWGQGTTLTVSS

SEQ ID NO: 70 - protein, 120 aa, Artificial Sequence
  Synthetic peptide
EVQLLESGGGLVQPGGSLRLSCAASGFTFSSAWMTWVRQAPGKGLEWVSTISASGSSKFYADSVKGRFTISRDNSKNTLYLQMNSLRAEDTAVYYCARSSGSYLYPFDYWGQGTTLTVSS

SEQ ID NO: 71 - protein, 120 aa, Artificial Sequence
  Synthetic peptide
EVQLLESGGGLVQPGGSLRLSCAASGFTFSDDAMSWVRQAPGKGLEWVSYINNGSSSKYYADSVKGRFTISRDNSKNTLYLQMNSLRAEDTAVYYCARARRPASQHFDYWGQGTTLTVSS

SEQ ID NO: 72 - protein, 118 aa, Artificial Sequence
  Synthetic peptide
EVQLLESGGGLVQPGGSLRLSCAASGFTFSNSWMTWVRQAPGKGLEWVSIISPGGNYTFYADSVKGRFTISRDNSKNTLYLQMNSLRAEDTAVYYCAKKSTPRAFDYWGQGTTLTVSS

SEQ ID NO: 73 - protein, 118 aa, Artificial Sequence
  Synthetic peptide
EVQLLESGGGLVQPGGSLRLSCAASGFTFSNAGMPWVRQAPGKGLEWVSAIRPDSSSTFYADSVKGRFTISRDNSKNTLYLQMNSLRAEDTAVYYCARSSIHDMFDYWGQGTTLTVSS

SEQ ID NO: 74 - protein, 118 aa, Artificial Sequence
  Synthetic peptide
EVQLLESGGGLVQPGGSLRLSCAASGFTFSADSMTWVRQAPGKGLEWVSAISTGGNNIYYADSVKGRFTISRDNSKNTLYLQMNSLRAEDTAVYYCAKFKAPELFDYWGQGTTLTVSS

SEQ ID NO: 75 - protein, 121 aa, Artificial Sequence
  Synthetic peptide
EVQLLESGGGLVQPGGSLRLSCAASGFTFSGDWMYWVRQAPGKGLEWVSSINSSSSNIFYADSVKGRFTISRDNSKNTLYLQMNSLRAEDTAVYYCARSNNSWPAQFFDYWGQGTTLTVSS

SEQ ID NO: 76 - protein, 118 aa, Artificial Sequence
  Synthetic peptide
EVQLLESGGGLVQPGGSLRLSCAASGFTFSTAGMSWVRQAPGKGLEWVSFISYDSSNKYYADSVKGRFTISRDNSKNTLYLQMNSLRAEDTAVYYCARNHPTMNFDYWGQGTTLTVSS

SEQ ID NO: 77 - protein, 119 aa, Artificial Sequence
  Synthetic peptide
EVQLLESGGGLVQPGGSLRLSCAASGFTFSAAGMPWVRQAPGKGLEWVSNIRSNSGTKFYADSVKGRFTISRDNSKNTLYLQMNSLRAEDTVVYYCARMDPMKHAFDYWGQGTTLTVSS

SEQ ID NO: 78 - protein, 119 aa, Artificial Sequence
  Synthetic peptide
EVQLLESGGGLVQPGGSLRLSCAASGFTFSTSSMNWVRQAPGKGLEWVSIIRPDGDYKYYADSVKGRFTISRDNSKNTLYLQMNSLRAEDTAVYYCARKEHFPQCFDYWGQGTTLTVSS

SEQ ID NO: 79 - protein, 118 aa, Artificial Sequence
  Synthetic peptide
EVQLLESGGGLVQPGGSLRLSCAASGFTFSDSWMHWVRQAPGKGLEWVSAINYGGGYIFYADSVKGRFTISRDNSKNTLYLQMNSLRAEDTAVYYCARLSYRQRFDYWGQGTTLTVSS

SEQ ID NO: 80 - protein, 121 aa, Artificial Sequence
  Synthetic peptide
EVQLLESGGGLVQPGGSLRLSCAASGFTFSDDGMYWVRQAPGKGLEWVSNIKANGSYTFYADSVKGPFTISRDNSKNTLYLQMNSLRAEDTAVYYCAKETTPRTCSRFDYWGQGTTLTVSS

SEQ ID NO: 81 - protein, 119 aa, Artificial Sequence
  Synthetic peptide
EVQLLESGGGLVQPGGSLRLSCAASGFTFSTAGMTWVRQAPGKGLEWVSTISTNSSNKFYADSVKGRFTISRDNSKNTLYLQMNSLRAEDTAVYYCARARNEDAQFDYWGQGTTLTVSS

SEQ ID NO: 82 - protein, 121 aa, Artificial Sequence
  Synthetic peptide
EVQLLESGGGLVQPGGSLRLSCAASGFTFSTDAMNWVRQAPGKGLEWVSAISANGSYKFYADSVKGRFTISRDNSKNTLYLQMNSLRAEDTAVYYCARLNLHMNQEYFDYWGQGTTLTVSS

SEQ ID NO: 83 - protein, 120 aa, Artificial Sequence
  Synthetic peptide
EVQLLESGGGLVQPGGSLRLSCAASGFTFSAASMSWVRQAPGKGLEWVSIINHDSNYTFYADSVKGRFTISRDNSKNTLYLQMNSLRAEDTAVYYCARSRPPRVLEFDYWGQGTTLTVSS

SEQ ID NO: 84 - protein, 121 aa, Artificial Sequence
  Synthetic peptide
EVQLLESGGGLVQPGGSLRLSCAASGFTFSNDGMSWVRQAPGKGLEWVSSIRNDSDTTFYADSVKGRFTISRDNSKNTLYLQMNSLRAEDTAVYYCAKEIDEAHRTIFDYWGQGTTLTVSS

SEQ ID NO: 85 - protein, 121 aa, Artificial Sequence
  Synthetic peptide
EVQLLESGGGLVQPGGSLRLSCAASGFTFSASAMTWVRQAPGKGLEWVSYISDDSSTTFYADSVKGRFTISRDNSKNTLYLQMNSLRAEDTAVYYCAKSMSAIPLWSFDYWGQGTTLTVSS

SEQ ID NO: 86 - protein, 120 aa, Artificial Sequence
  Synthetic peptide
EVQLLESGGGLVQPGGSLRLSCAASGFTFSSAWMNWVRQAPGKGLEWVSDIKDSSNNIYYADSVKGRFTISRDNSKNTLYLQMNSLRAEDTAVYYCARTPSARSSLFDYWGQGTTLTVSS

SEQ ID NO: 87 - protein, 121 aa, Artificial Sequence
  Synthetic peptide
EVQLLESGGGLVQPGGSLRLSCAASGFTFSGDWMSWVRQAPGKGLEWVSSINSNGSSIYYADSVKGRFTISRDNSKNTLYLQMNSLRAEDTAVYYCARHKCPLRRTGFDYWGQGTTLTVSS

SEQ ID NO: 88 - protein, 120 aa, Artificial Sequence
  Synthetic peptide
EVQLLESGGGLVQPGGSLRLSCAASGFTFSDDSMNWVRQAPGKGLEWVSVISSDGNNIYYADSVKGRFTISRDNSKNTLYLQMNSLRAEDTAVYYCARNPDSRTTKFDYWGQGTTLTVSS

SEQ ID NO: 89 - protein, 120 aa, Artificial Sequence
  Synthetic peptide
EVQLLESGGGLVQPGGSLRLSCAASGFTFSSDWMNWVRQAPGKGLEWVSTISNNSGYIYYADSVKGRFTISRDNSKNTLYLQMNSLRAEDTTVYYCARFYDVPPNQFDYWGQGTTLTVSS

SEQ ID NO: 90 - protein, 118 aa, Artificial Sequence
  Synthetic peptide
EVQLLESGGGLVQPGGSLRLSCAASGFTFSTDWMHWVRQAPGKGLEWVSFINHNGDYKYYADSVKGRFTISRDNSKNTLYLQMNSLRAEDTAVYYCARERVRMPFDYWGQGTTLTVSS

SEQ ID NO: 91 - protein, 120 aa, Artificial Sequence
  Synthetic peptide
EVQLLESGGGLVQPGGSLRLSCAASGFTFSDAAMHWVRQAPGKGLEWVSSINDGGNSKYYADSVKGRFTISRDNSKNTLYLQMNSLRAEDTAVYYCARKYMDPTIKFDYWGQGTTLTVSS

SEQ ID NO: 92 - protein, 121 aa, Artificial Sequence
  Synthetic peptide
EVQLLESGGGLVQPGGSLRLSCAASGFTFSNYAMPWVRQAPGKGLEWVSFINHNGDTTYYADSVKGRFTISRDNSKNTLYLQMNSLRAEDTAVYYCAKFSKMLKVHDFDYWGQGTTLTVSS

SEQ ID NO: 93 - protein, 121 aa, Artificial Sequence
  Synthetic peptide
EVQLLESGGGLVQPGGSLRLSCAASGFTFSDSSMTWVRQAPGKGLEWVSTISAGGGNTYYADSVKGRFTISRDNSKNTLYLQMNSLRAEDTAVYYCARTRKDWFYYSFDYWGQGTTLTVSS

SEQ ID NO: 94 - protein, 118 aa, Artificial Sequence
  Synthetic peptide
EVQLLESGGGLVQPGGSLRLSCAASGFTFSDYWMTWVRQAPGKGLEWVSNISPNSDNKYYADSVKGRFTISRDNSKNTLYLQMNSLRAEDTAVYYCAKCRSGTMFDYWGQGTTLTVSS

SEQ ID NO: 95 - protein, 120 aa, Artificial Sequence
  Synthetic peptide
EVQLLESGGGLVQPGGSLRLSCAASGFTFSADAMSWVRQAPGKGLEWVSVISDGSNTTFYADSVKGRFTISRDNSKNTLYLQMNSLRAEDTAVYYCAKRLPPTKLLFDYWGQGTTLTVSS

SEQ ID NO: 96 - protein, 118 aa, Artificial Sequence
  Synthetic peptide
EVQLLESGGGLVQPGGSLRLSCAASGFTFSAAWMHWVRQAPGKGLEWVSVISNNSSNIFYADSVKGRFTISRDNSKNTLYLQMNSLRAEDTAVYYCARCYEPRHFDYWGQGTTLTVSS

SEQ ID NO: 97 - protein, 118 aa, Artificial Sequence
  Synthetic peptide
EVQLLESGGGLVQPGGSLRLSCAASGFTFSADAMPWVRQAPGKGLEWVSNIRYGSGNIYYADSVKGRFTISRDNSKNTLYLQMNSLRAEDTAVYYCARDFLHKKFDYWGQGTTLTVSS

SEQ ID NO: 98 - protein, 120 aa, Artificial Sequence
  Synthetic peptide
EVQLLESGGGLVQPGGSLRLSCAASGFTFSSDSMSWVRQAPGKGLEWVSPINNDGDTKYYADSVKGRFTISRDNSKNTLYLQMNSLRAEDTAVYYCARRASHRGHGFDYWGQGTTLTVSS

SEQ ID NO: 99 - protein, 120 aa, Artificial Sequence
  Synthetic peptide
EVQLLESGGGLVQPGGSLRLSCAASGFTFSNSSMTWVRQAPGKGLEWVSFINNSGDYIYYADSVKGRFTISRDNSKNTLYLQMNSLRAEDTAVYYCAKRSTAPNVHFDYWGQGTTLTVSS

SEQ ID NO: 100 - protein, 120 aa, Artificial Sequence
  Synthetic peptide
EVQLLESGGGLVQPGGSLRLSCAASGFTFSDSAMYWVRQAPGKGLEWVSYISSDSDSTFYADSVKGRFTISRDNSKNTLYLQMNSLRAEDTAVYYCARLRPRIWCPFDYWGQGTTLTVSS

SEQ ID NO: 101 - protein, 118 aa, Artificial Sequence
  Synthetic peptide
EVQLLESGGGLVQPGGSLRLSCAASGFTFSNYGMTWVRQAPGKGLEWVSFISYGGNYIYYADSVKGRFTISRDNSKNTLYLQMNSLRAENTAVYYCAKENNHSPFDYWGQGTTLTVSS

SEQ ID NO: 102 - protein, 121 aa, Artificial Sequence
  Synthetic peptide
EVQLLESGGGLVQPGGSLRLSCAASGFTFSSDWMSWVRQAPGKGLEWVSIINSGGDNTFYADSVKGRFTISRDNSKNTLYLQMNSLRAEDTAVYYCARDHAWLNALSFDYWGQGTTLTVSS

SEQ ID NO: 103 - protein, 118 aa, Artificial Sequence
  Synthetic peptide
EVQLLESGGGLVQPGGSLRLSCAASGFTFSDAWMTWVRQAPGKGLEWVSAINYDSGYKYYADSVKGRFTISRDNSKNTLYLQMNSLRAEDTAVYYCAKYKPPERFDYWGQGTTLTVSS

SEQ ID NO: 104 - protein, 119 aa, Artificial Sequence
  Synthetic peptide
EVQLLESGGGLVQPGGSLRLSCAASGFTFSADWMYWVRQAPGKGLEWVSNINAGGNYIYYADSVKGRFTISRDNSKNTLYLQMNSLRAEDTAVYYCARQDLPHPCFDYWGQGTTLTVSS

SEQ ID NO: 105 - protein, 118 aa, Artificial Sequence
  Synthetic peptide
EVQLLESGGGLVQPGGSLRLSCAASGFTFSNASMPWVRQAPGKGLEWVSAIKSGGGYKFYADSVKGRFTISRDNSKNTLYLQMNSLRAEDTAVYYCAKKSTTPIFDYWGQGTTLTVSS

SEQ ID NO: 106 - protein, 119 aa, Artificial Sequence
  Synthetic peptide
EVQLLESGGGLVQPGGSLRLSCAASGFTFSAYWMHWVRQAPGKGLEWVSAISTSSNYKFYADSVKGRFTISRDNSKNTLYLQMNSLRAEDTAVYYCAKSRRPSHTFDYWGQGTTLTVSS

SEQ ID NO: 107 - protein, 121 aa, Artificial Sequence
  Synthetic peptide
EVQLLESGGGLVQPGGSLRLSCAASGFTFSAASMHWVRQAPGKGLEWVSVIKTSSGSTYYADSVKGRFTISRDNSKTTLYLQMNSLRAEDTAVYYCAKRNLSLIMRPFDYWGQGTTLTVSS

SEQ ID NO: 108 - protein, 118 aa, Artificial Sequence
  Synthetic peptide
EVQLLESGGGLVQPGGSLRLSCAASGFTFSNAGMHWVRQAPGKGLEWVSTISASGNSKFYADSVKGRFTISRDNSKNTLYLQMNSLRAEDTAVYYCAKPKNWQVFDYWGQGTTLTVSS

SEQ ID NO: 109 - protein, 118 aa, Artificial Sequence
  Synthetic peptide
EVQLLESGGGLVQPGGSLRLSCAASGFTFSTYSMPWVRQAPGKGLEWVSYIRPSGNTIFYADSVKGRFTISRDNSKNTLYLQMNSLRAEDTAVYYCAKSLAGALFDYWGQGTTLTVSS

SEQ ID NO: 110 - protein, 118 aa, Artificial Sequence
  Synthetic peptide
EVQLLESGGGLVQPGGSLRLSCAASGFTFSGYGMPWVRQAPGKGLEWVSFIKAGSGTTYYADSVKGRFTISRDNSKNTLYLQMNSLRAEDTAVYYCAKQIHNHVFDYWGQGTTLTVSS

SEQ ID NO: 111 - protein, 121 aa, Artificial Sequence
  Synthetic peptide
EVQLLESGGGLVQPGGSLRLSCAASGFTFSNSGMHWVRQAPGKGLEWVSFIRPSSSNKFYADSVKGRFTISRDNSKNTLYLQMNSLRAEDTAVYYCAKSESRYKSPPFDYWGQGTTLTVSS

SEQ ID NO: 112 - protein, 118 aa, Artificial Sequence
  Synthetic peptide
EVQLLESGGGLVQPGGSLRLSCAASGFTFSTYSMPWVRQAPGKGLEWVSNIRSNSNTIFYADSVKGRFTISRDNSKNTLYLQMNSLRAEDTAVYYCAKLQMASMFDYWGQGTTLTVSS

SEQ ID NO: 113 - protein, 121 aa, Artificial Sequence
  Synthetic peptide
EVQLLESGGGLVQPGGSLRLSCAASGFTFSNYAMTWVRQAPGKGLEWVSYISSDGNYTYYADSVKGRFTISRDNSKNTLYLQMNSLRAEDTAVYYCAKDSCESMDANFDYWGQGTTLTVSS

SEQ ID NO: 114 - protein, 120 aa, Artificial Sequence
  Synthetic peptide
EVQLLESGGGLVQPGGSLRLSCAASGFTFSTAWMHWVRQAPGKGLEWVSFINDSGGYTFYADSVKGRFTISRDNSKNTLYLQMNSLRAEDTAVYYCAKNGRDGYEYRFDYWGQGTTLVSS

SEQ ID NO: 115 - protein, 120 aa, Artificial Sequence
  Synthetic peptide
EVQLLESGGGLVQPGGSLRLSCAASGFTFSTSSMSWVRQAPGKGLEWVSTISASGGYKFYADSVKGRFTISRDNSKNTLYLQMNSLRAEDTAVYYCAKTSMRQSGLFDYWGQGTTLTVSS

SEQ ID NO: 116 - protein, 119 aa, Artificial Sequence
  Synthetic peptide
EVQLLESGGGLVQPGGSLRLSCAASGFTFSSYSMNWVRQAPGKGLEWVSNIRSNSGSIFYADSVKGRFTISRDNSKNTLYLQMNSLRAEDTAVYYCAKDLVMGTRFDYWGQGTTLTVSS

SEQ ID NO: 117 - protein, 121 aa, Artificial Sequence
  Synthetic peptide
EVQLLESGGGLVQPGGSLRLSCAASGFTFSADAMPWVRQAPGKGLEWVSYINASSNSIFYADSVKGRFTISRDNSKNTLYLQMNSLRAEDTAVYYCARNVLPPLNAKFDYWGQGTTLTVSS